(19) United States
(12) Patent Application Publication
(10) Pub. No.: US 2009/0048957 A1
(43) Pub. Date: Feb. 19, 2009

(54) Method and system for financial counseling

(76) Inventor: Matthew Celano, Winter Garden, FL (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 12/080,422

(22) Filed: Apr. 2, 2008

Related U.S. Application Data
(60) Provisional application No. 60/921,437, filed on Apr. 2, 2007.

(51) Int. Cl. G06Q 40/00

(52) U.S. Cl. 705/35

(57) ABSTRACT

Financial institutions providing counseling to costumers have to spend a significant amount of time gathering data from their clients and analyzing that data before offering appropriate financial advice to their customers. Some Debt Management Programs allow costumers to enroll using online systems without appropriate education or counseling. The present invention allows a costumer to obtain financial counseling automatically. A Credit Report Data Integration system, furthermore, streamlines the process by allowing the system to obtain data, with consent of the customer, from the credit bureaus to determine the financial needs of the client. The system allows the counselor to concentrate on counseling the client, instead of dealing with data entry and analysis. Furthermore, the client has the opportunity, if desired, to receive counseling from the system without having to actually meet a counselor.

### CROSS-REFERENCE TO RELATED APPLICATION

This application is based upon and claims benefit of copending and co-owned U.S. Provisional Patent Application Ser. No. 60/921,437, filed with the U.S. Patent and Trademark Office on Apr. 2, 2007 by the inventor herein entitled “Method and System for Financial Counseling,” the specification of which is incorporated herein by reference in its entirety.

### BACKGROUND OF THE INVENTION

### Field of the Invention

The present invention relates generally to methods and systems for consumer credit report data analysis, intelligent reporting, adaptive counseling, and education. In particular, it provides a customized interactive debt management education tool that may be utilized to analyze a person's financial situation and develop an adaptive action plan outlining steps to improve the person's financial standing.

### BACKGROUND OF THE INVENTION

Generally, a financial counselor speaks with his or her client and gathers information in order to provide financial advice. When a client's financial situation is complex, the counselor and client usually must speak again, at a later date, in order to allow the counselor sufficient time to analyze the data. As a result, financial counselors spend a great deal of time gathering and analyzing client data as opposed to counseling clients. On the other hand, when the situation is not complex, prospective clients may not want to spend the time to speak with an advisor and may sometimes make uninformed choices.

With the advent of the Internet, financial counseling firms have had the opportunity to create web pages where prospective clients can learn about the company, request information, and schedule time with a financial counselor. Many websites contain means of collecting basic data for use by the company to whom the website belongs. Some financial counseling entities have created debt management programs (DMPs), and other financial planning programs, in which a client can enroll over the Internet. These institutions, however, usually do not provide any counseling or education to their prospective customers before enrollment in programs that the institution may offer.

While some methods directed to gathering information from prospective clients on Internet sites exist. None of the methods specifically teaches the concept of gathering the information, compiling it in a usable format, automatically analyzing it, and providing results to a financial counselor or client. Accordingly, there remains a need for a method of financial counseling that streamlines the data gathering process and provides ready access information to a financial counselor or the direct user of a financial counseling application.

### SUMMARY OF THE INVENTION

The present invention provides a solution to the above and other problems by enabling a method of counseling individuals on financial matters and providing the tools to accomplish the goal of providing comprehensive financial counseling.

In a first aspect of the present invention, a financial counseling method is enabled in which a webpage contains fields that a client can complete with pertinent information such as personal spending history, budget, and credit information. The information that the client enters is automatically processed and the system provides primary, secondary, and alternate solutions based on the input data. The client, or a counselor, can view the results immediately and make an informed decision as to the best solution to use. The counselor can also use that information to answer any questions the client may have.

In accordance with another aspect of the present invention, some of the required information can be downloaded directly from a credit bureau, in addition to the information that the client enters manually. This approach reduces the amount of time that the client has to spend completing the forms.

Another embodiment of the present invention includes a creditor logic tool that enables the user to address requirements and benefits from creditors. This embodiment may contain a creditor mapping tool that will map an individual creditor to a creditor ID in the system. An additional aspect of the present invention includes a financial action planning tool that enables the user to determine the necessary changes to the customer's spending patterns in order to achieve the customer's financial goals.

A further embodiment of the present invention relates to a Financial Action Plan. The Financial Action Plan is an interactive tool that can be utilized during a counseling session or while using the program to help individuals and their families with their budgeting needs. This tool enables the counselor or consumer to guide the client in making the necessary changes to the client's spending patterns and achieve the client's financial goals.

In yet another aspect of the present invention, the client is provided information to allow the client to make an informed decision when selecting a specific course of action. The information is provided in multiple formats and it reflects the client's financial situation. Other and additional objects of this invention will become apparent from a consideration of this entire specification.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a flowchart of the solutions process.

FIG. 2 illustrates a graphic user interface for a particular embodiment of the invention displaying fields to be completed by a user of the invention.

FIGS. 2a-d show enlarged portions of the particular embodiment shown in FIG. 3.

FIG. 3 is a flowchart of creditor matching.

FIG. 4 illustrates some of the notification symbols presented to the client.

FIG. 5 shows an example of the benefits available to the client from each particular creditor in the respective account.

FIG. 6 illustrates a graphical depiction of the different plans available to the client.

FIG. 7 illustrates another depiction of the different plans available to the client.

FIG. 8 displays the graphical interface that allows the client to select specific plans for review.

FIG. 9 shows an embodiment of the present invention that displays the user's financial health as a result of the information gathered.

FIGS. 9a-b shows an embodiment of the invention that provides a user with specific recommendations based upon information gathered throughout the process.

### DETAILED DESCRIPTION

The invention summarized above and defined by the enumerated claims may be better understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent embodiments do not depart from the spirit and scope of the invention in its broadest form.

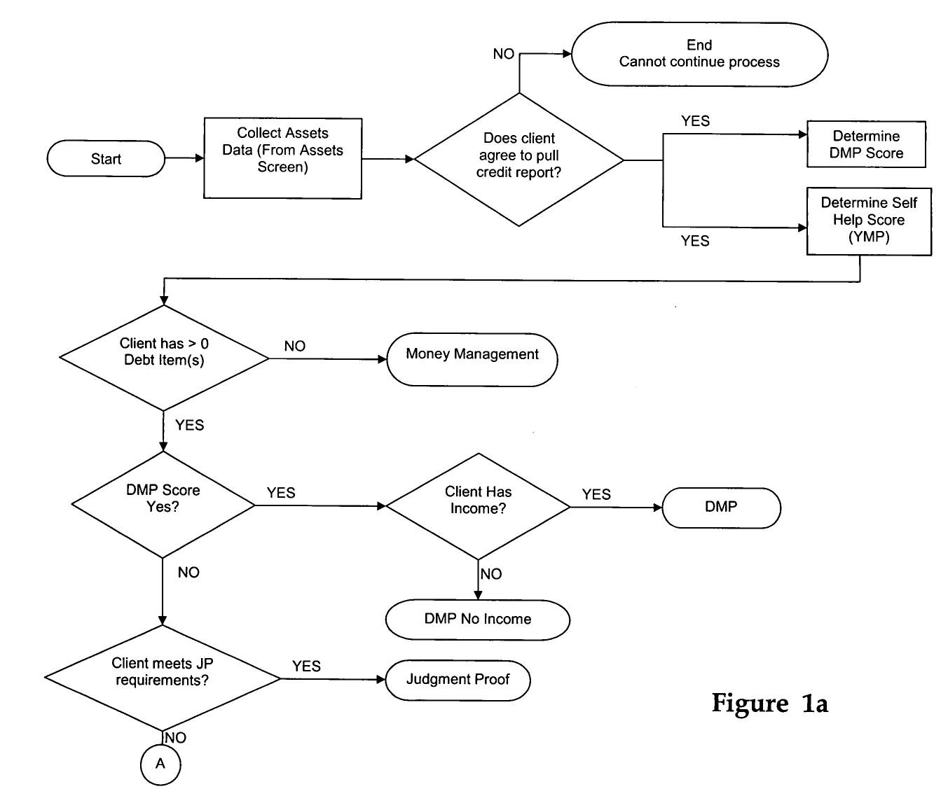

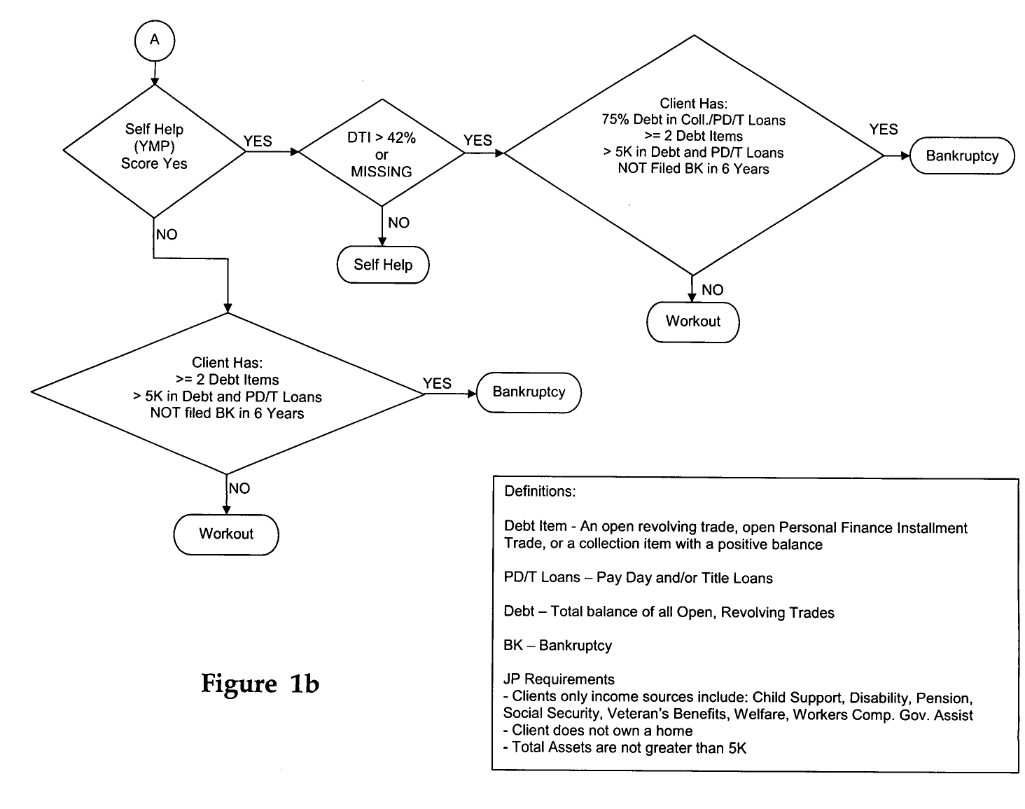

In an effort to solve the above-described problem, a counseling system is provided. The system or method can be utilized by financial institutions, financial service providers, and other entities that provide financial services and education. It can also be used by any other entity offering such services to consumers or gathering information from consumers, and such institutions are referred to in the current description as financial institutions, providers, and similar names. As shown in FIG. 1, a prospective client accesses the counseling service's website, or the appropriate software, where the client is asked to provide information for asset data collection regarding his or her financial information. After the client provides all the required information, the system processes the information, displays the results, and makes recommendations. The client views the results and selects a course of action or calls a counselor. If the client calls for assistance, a counselor reviews the results and then advises the client. The client then selects a course of action. In other embodiments of the present invention, a provider utilizes the information to make decisions as to the services available to that client.

The courses of action provided by the system include primary, alternative, and secondary solutions. The primary solution is the main course of action the consumer is advised to take in order to solve their current condition, e.g. money management, debt management, judgment proof, self-help, bankruptcy, and workout, among others. Alternative solutions are based on the client's assets, in some cases, provide short term fixes to the consumers situation, and require the consumer to leverage assets in order to utilize these types of solutions. For example, the consumer may have to take a loan against their 401K plan in order to pay off some debt. Some examples of alternative solutions include 401K benefits, Liquidating Assets to pay off debt, Home Equity Lines of Credit (HELOC), second mortgage, or home equity loans, reverse mortgages, lump sum debt settlements. The system also provides Secondary Solutions. These solutions are specific and address only one condition. Some examples include BrightScore to improve credit scores and social services for loss of income. The system also provides financial action plans that the client can utilize to improve his or her financial situation.

During the asset collection step, the client is asked to allow the system to retrieve the client's credit report. If the client denies permission to retrieve the credit report, the process terminates. Once the client agrees to the retrieval of the credit score, a soft-hit credit report is retrieved from a credit bureau. A Credit Report Data Integration (CRDI) system assigns the data gathered from the credit report to its specific data attributes that are then given predetermined weights to determine client's DMP, Self Help (YMP), and other scores to be utilized during the counseling process.

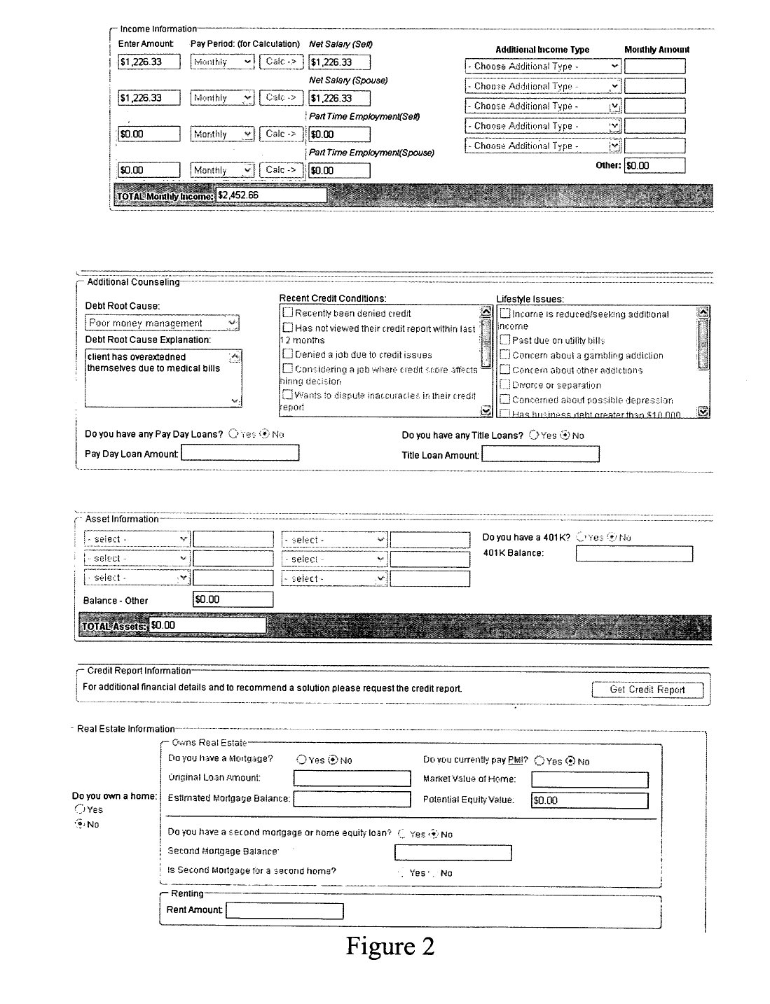

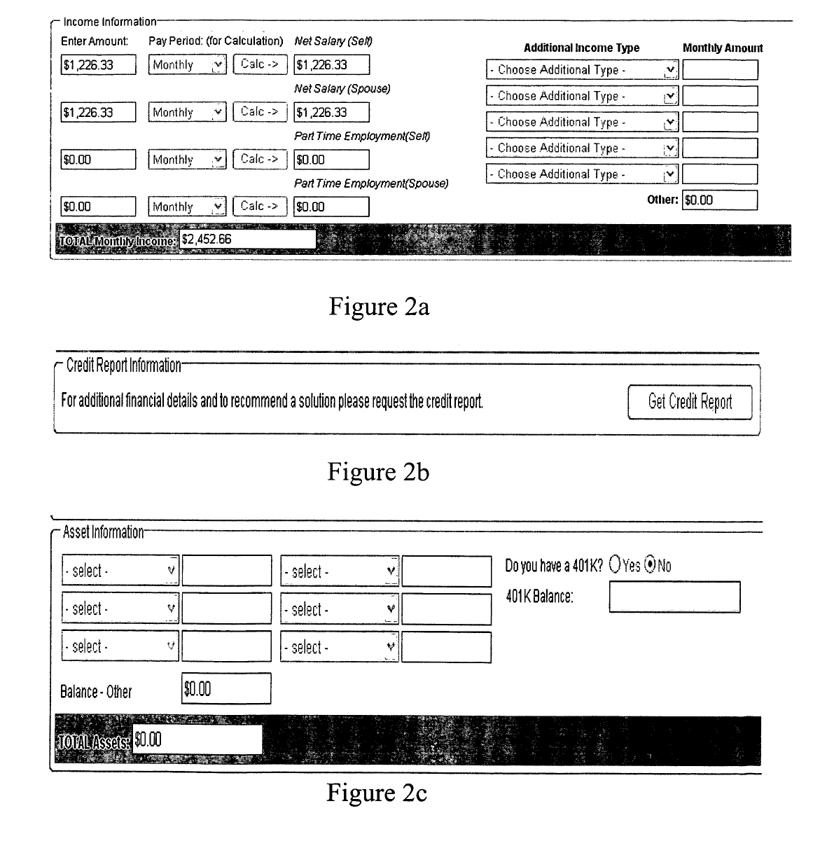

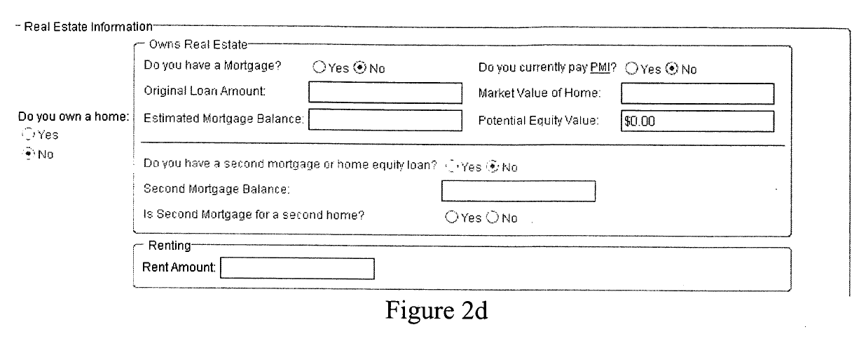

In the asset collection step, the client is asked for information regarding the client's financial situation, credit condition, lifestyle and other information that can be used to determine appropriate solutions for the client and the root cause of the client's situation. The consumer is presented with a graphical user interface (GUI) as illustrated in FIGS. 2 and 2a-2d, where the GUI can be used in different embodiments of the present invention to collect the information required to provide advice to the consumer. These representations can be arranged in different configurations. Some embodiments of the present invention may contain additional fields and in other embodiments, some fields may be removed. In FIG. 2 the GUI is divided into four fields: Income Information (FIG. 2a), Credit Report Information (FIG. 2b), Asset Information (FIG. 2c), and Real Estate Information (FIG. 2d).

The Income Information (FIG. 2a) portion of the screen enables the client to provide monthly, annual, weekly, or bi-weekly salary if any; the client's spouse's monthly, annual, weekly, or bi-weekly salary if any; the client's part-time monthly, annual, weekly, or bi-weekly salary if any; and any other part-time monthly, annual, weekly, or bi-weekly salary that a client may have earned. The Income Information section also provides fields for other types of income such as fixed income, alimony, ongoing support, and other types of income a client may be receiving. The screen displays the total income calculated from the information entered in that section.

The Credit Report Information (FIG. 2b) section of the web inquiry screen provides two options: get credit report and declined credit report. As explained previously, CRDI system processes the information if a client selects “get credit report,” but if the client declines to get his or her credit report, the system terminates and the consumer may or may not be provided with additional information.

FIG. 2c represents the Asset Information portion of the web inquiry, where the client is asked to choose from lists of different asset types, e.g. checking account, savings account, and the client is also given the opportunity to choose additional assets and their value. Another portion of the Asset Information section asks the client whether he or she is participating or has invested in a 401K plan, giving them the option to choose yes or no, the amount invested, and the date of hire. The Asset Information section may also include options for other retirement assets.

Another section of the web inquiry screen asks the client to provide Real Estate Information (FIG. 2d). It inquires whether the person owns a home, has encumbered the property with a home equity loan (including the original loan amount and estimate mortgage balance), and also whether the person currently pays Private Mortgage Insurance (PMI), the market value of the home and the estimated mortgage balance. Financial institutions may create additional sections in the web inquiry to gather information about the client. That information is utilized to develop action plans for each client.

Once all information is gathered, or at the same time information is being gathered, CRDI assigns all the information gathered to its specific attributes. A soft-hit credit report in a Full File Fixed format, or any other compatible format, is downloaded from a credit bureau into CRDI. The system creates specific data attributes from the information gathered in the report. The data attributes are described in the following Table 1, the weights for each attribute change according to the parameters set by each provider. The attributes can be utilized to determine the consumer's credit, DMP, YMP, and any other score that the provider may utilize in developing programs for specific types of clients.

TABLE 1

| Varibles | Intervals | Weights |
|---|---|---|
| Base | Base weight assigned to all files | 754 |
| Number of Inquiries in the | Missing | 34 |
| Last 12 Months | 0-1 | 34 |
| INQ121 | 2-6 | 0 |
| | 7-10 | −19 |
| | 11-14 | −37 |
| | 15 or more | −62 |
| Number of Total Revolving | 0 | −233 |
| Trades | 1 | −125 |
| TOTRD12 | 2 | −71 |
| | 3 | −41 |
| | 4 or more | 0 |
| Number of Open Bank | Missing | 0 |
| Revolving Trades with | 0-3 | 0 |
| Max(High Credit, Credit | 4 or more | −93 |
| Limit) >=$7500 | | |
| HCG75_3 | | |
| Age of Oldest Bank | No Trades with valid | 0 |
| Revolving Trade in Months | open date | |
| OLDAG3 | No Bank Rev Trades | 0 |
| | 0-10 | −60 |
| | 11 or more | 0 |
| Number of Total Trades | Missing | 0 |
| Reported as Past Due in the | 0-1 | 0 |
| Last 3 Months | 2-6 | −29 |
| PSTDU1 | 7 or more | −82 |
| Number of Personal Finance | Missing | 0 |
| Installment Trades Reported | 0 | 0 |
| as Past Due in the Last 3 | 1 or more | −56 |
| Months | | |
| PSTDU10 | | |
| Number of Total Trades | Missing | 0 |
| Rated Worst Ever 30 or 60 | 0-1 | 0 |
| Days Delinquent | 2 | 34 |
| T3060_1 | 3 | 39 |
| | 4 | 44 |
| | 5 or more | 54 |
| Number of Total Trades | Missing | 0 |
| Rated Worst Ever 90+ Days | 0-1 | 0 |
| Delinquent (Excludes Trade | 2 | 20 |
| Derogatories) | 3 or more | 48 |
| TOT90_1 | | |
| Number of Derogatory | 0-1 | 30 |
| Public Record and | 2-4 | 0 |
| Collection Items | 5-6 | −38 |
| TOTPRCO | 7-8 | −53 |
| | 9 or more | −73 |
| Number of Mortgage Trades | Missing | 0 |
| Rated Worst Ever 60+ Days | 0 | 0 |
| Delinquent or Trade | 1 or more | −30 |
| Derogatory | | |
| PLUS60_11 | | |
| Percent of Active Total | Missing | 0 |
| Trades in the Last 6 Months | 0-34 | 0 |
| ACTIVE1 | 35 or more | 30 |
| Ratio of Total Balance to | No Rev. Trades w/ | 0 |
| Total High Credit for | High Credit | |
| Revolving Trades, Reported | 0% to 60% | 0 |
| in the Last 12 Months | 61% to 85% | 31 |
| RATIO12 | 86% or more | 49 |
| Debt to Income Ratio | Missing | −37 |
| (calculated from the credit | 0% to 5% | −37 |
| bureau) | 6% to 20% | 0 |
| DBTINCRATIO | 21% to 100% | 18 |
| | 101% to 180% | 0 |
| | 181% or more | −33 |

The attributes that CRDI creates can be used in an Automated Decisioning, Creditor Matching and Creditor Logic aspects of an embodiment of the present invention.

These parameters can be utilized by financial institutions to develop a number of plans to address their clients' needs. In one embodiment of the present invention, an institution can utilize the client's DMP and YMP scores to determine the best plan or course of action for the client. In order to determine the DMP Score, values in a scorecard are run against the information retrieved automatically from the credit report. Table 2, below, illustrates the variables, intervals and weights for each entry found in the credit report utilized in one embodiment of the present invention to determine the client's DMP, YMP, and any other score. The variables, intervals, and weights shown in Table 2 are only illustrative and they can be changed by the financial institution or other entity utilizing any embodiment of the present invention. Such changes may be made depending on the specific organization's standards. Furthermore, a provider may utilize a single score card for every program it offers, changing only the required scores necessary to enroll or utilize that specific program.

TABLE 2

| VARIABLES | INTERVALS | WEIGHTS |
|---|---|---|
| Base | Base weight assigned | 713 |
| Number of | to all files | |
| Inquiries in the | Missing | 21 |
| Last 12 Months | 0-1 | 21 |
| INQ121 | 2-6 | 0 |
| | 7-10 | −11 |
| | 11-14 | −19 |
| | 15 or more | −39 |
| Number of Revolving | 0 | −157 |
| Trades | 1 | −94 |
| TOTRD12 | 2 | −63 |
| | 3 | −34 |
| | 4 or more | 0 |
| Number of Open Bank | Missing | 0 |
| Revolving Trades with Max | 0-3 | 0 |
| (High Credit, Credit | 4 or more | −43 |
| Limit) >=$7500 | | |
| HCG75_3 | | |
| Age of Oldest Bank | No Trades with valid | 0 |
| Revolving Trade in Months | open date | |
| OLDAG3 | 0-10 | −39 |
| | 11 or more | 0 |
| Number of Total Trades | Missing | 0 |
| Reported as Past Due in the | 0-1 | 0 |
| Last 3 Months | 2-6 | −18 |
| PSTDU1 | 7 or more | −41 |
| Number of Personal Finance | Missing | 0 |
| Installment Trades Reported | 0 | 0 |
| as Past Due in the Last 3 | 1 or more | −37 |
| Months | | |
| PSTDU10 | | |
| Number of Total Trades | Missing | 0 |
| Rated Worst Ever 30 or 60 | 0-1 | 0 |
| Days Delinquent | 2 | 23 |
| T30601 | 3 | 26 |
| | 4 | 37 |
| | 5 or more | 39 |
| Number of Total Trades | Missing | 0 |
| Rated Worst Ever 90+ Days | 0-1 | 0 |
| Delinquent (Excludes Trade | 2 | 10 |
| Derogatories) | 3 or more | 30 |
| TOT90_1 | | |
| Number of Derogatory | Missing | 0 |
| Public Record and | 0-1 | 24 |
| Collection Items | 2-4 | 0 |
| TOTPC | 5-6 | −27 |
| | 7-8 | −34 |
| | 9 or more | −40 |
| Number of Mortgage Trades | Missing | 0 |
| Rated Worst Ever 60+ Days | 0 | 0 |
| Delinquent or Trade | 1 or more | −16 |
| Derogatory | | |
| PLUS60_11 | | |
| Percent of Active Total | Missing | 0 |
| Trades in the Last 6 Months | 0-34 | 0 |
| ACTIVE1 | 35 or more | 21 |
| Ratio of Total Balance to | No Rev. Trades w/ | 0 |
| Total High Credit for | High Credit | |
| Revolving Trades, Reported | 0% to 60% | 0 |
| in the Last 6 Months | 61% to 85% | 23 |
| RATIO126 | 86% or more | 26 |
| Debt to Income Ratio | Missing | 0 |
| DBTINCRATIO = MDEBT/ | 0% to 20% | 0 |
| cNetSalarySelf* 100 | 21% to 100% | 20 |
| | 101% to 140% | 0 |
| | 141% to 300% | −18 |
| | 301% to 600% | −26 |
| | 600% or more | −42 |

After all the weights for a particular client are determined, the system adds the values and the total corresponds to the client's DMP, YMP, and any other score.

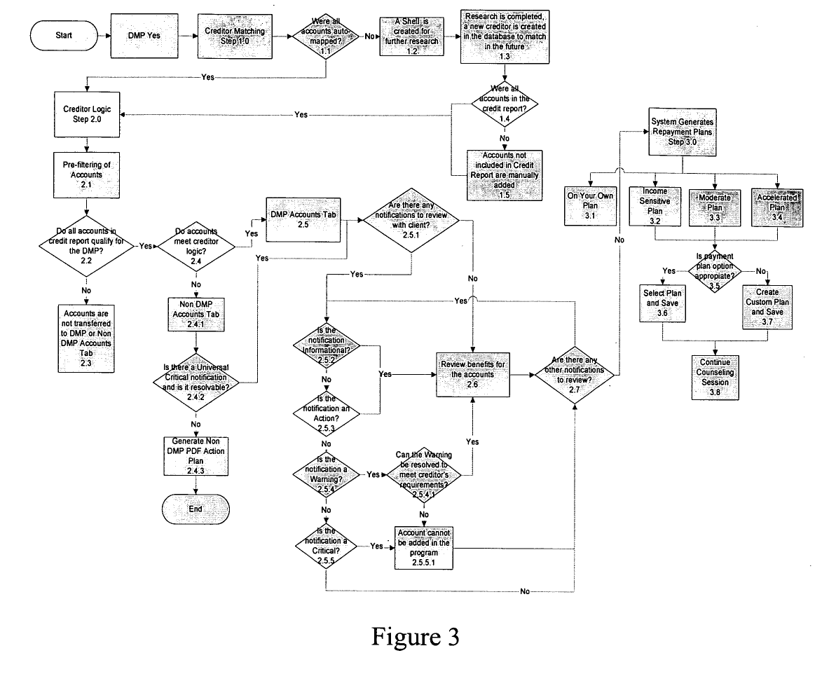

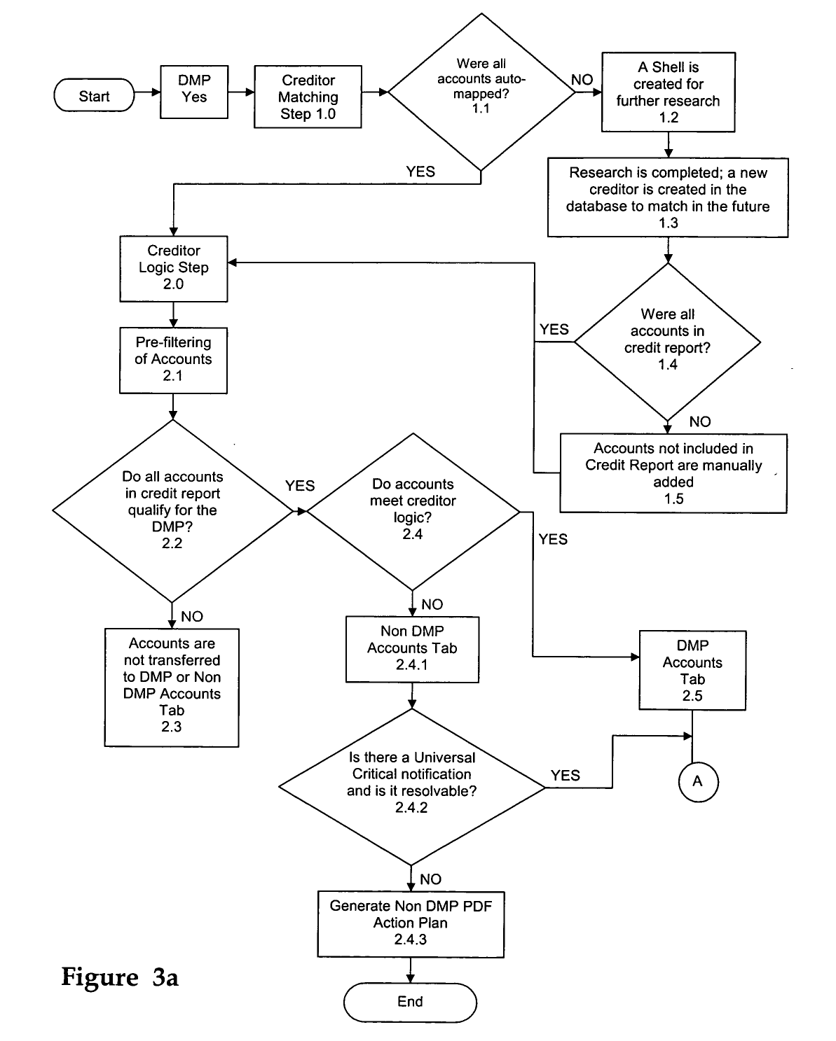

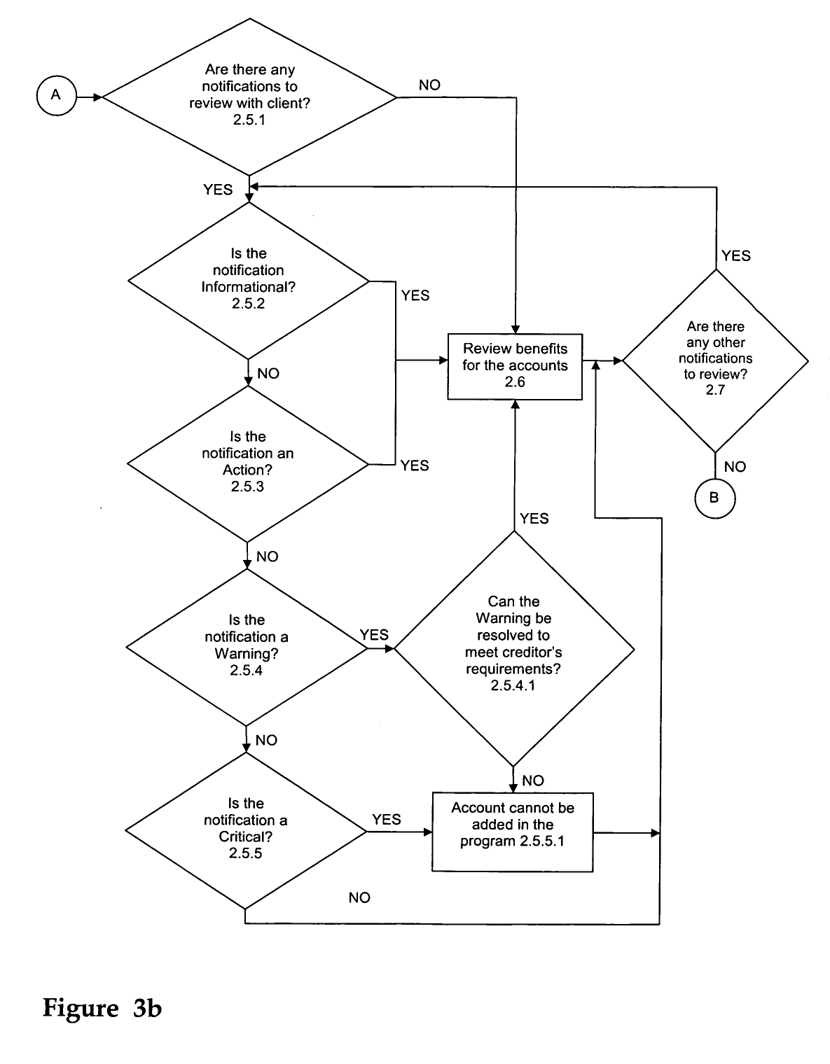

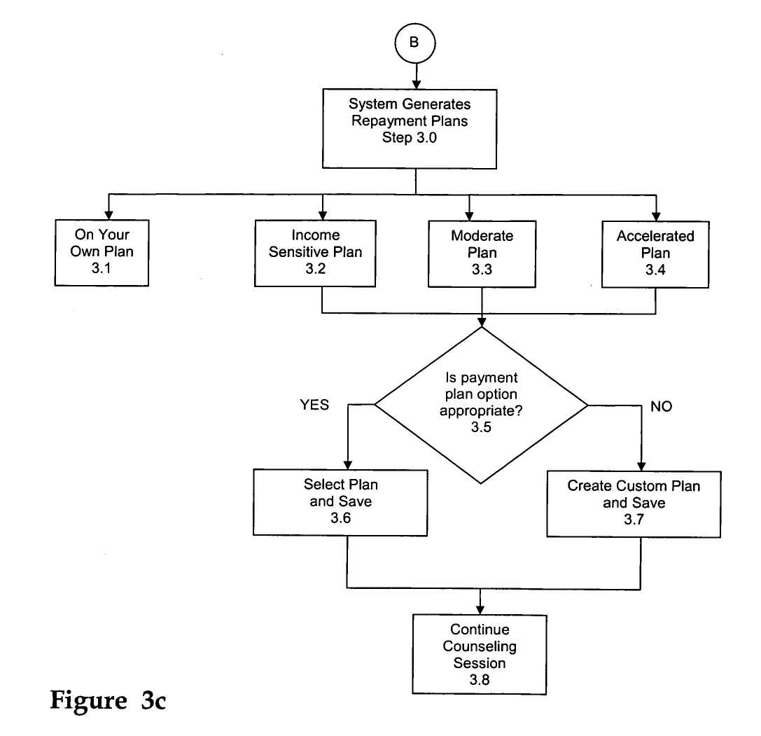

Each institution determines what score is necessary to qualify for enrollment for that institution's DMP. If the client qualifies for the DMP, the Creditor Matching Tool begins to run in the background. The Creditor Matching Tool allows a user to map an individual creditor from the credit report to a creditor ID in the system. This tool maps an individual creditor from the credit report to a creditor ID in the system. The matching system pulls the individual account information (subscriber name and subscriber code) from a credit report and identifies the match or “mapping” in the system. Each of these mappings by subscriber name and code, must be identified, researched, and mapped for every individual creditor. The process for Creditor Matching is illustrated in FIG. 3.

Each of these “mappings” is done individually by the system since each creditor has their own unique subscriber name and code. To acquire this information the system verifies the creditor's address via the credit report and find a match to that creditor and creditor ID. Once the research has been completed and a match has been identified, the mapping or assignment procedure begins as explained below.

Once the mapping has been added to the “Mappings List” and saved, a one to one match is then applied directly to a production database. The next credit report that is pulled with the subscriber name and code that was just activated, auto matches to the assigned creditor ID. After the system is updated with the specific creditor, the creditor ID is stored in the system and can be used to map future user's creditors. If a subscriber name and code are researched and there is no existing creditor ID that matches the address in the credit bureau utilized for obtaining the client's credit report, a creditor “shell” and ID is created for the assignment process (the “shell” information is verified once the client's account state shows as “Active” under that creditor ID). The subscriber (creditor) name and code is then manually matched. If the creditor did not exist then the shell becomes an actual new creditor to be added to the “Mapping Lists” and saved in the production database. Accounts not included in the credit report are manually matched. Once the mapping/matching takes place, the next step is to apply the Creditor Logic Tool.

Creditor Logic Tool is the application created to manage creditor logic. This application is linked to a number of other applications in the system. The Creditor Logic Tool incorporates the following components to the counseling session: creditor requirements, pre-filter of accounts (filter of accounts to DMP Tab or Non DMP Tab), account notifications, creditor benefits, and repayment plans. Additional components may be utilized as required by each provider. Below is an explanation of each component. First, a Creditor Logic Spreadsheet provides a list of creditor notifications.

Next, Creditor Logic identifies creditor requirements. There are a number of rules and other criteria that creditors require specifically in order for an account to be accepted into a DMP. For example: Some creditors require accounts to be 6 months old; others require at least 9 months. The Creditor Logic Tool also allows counselors to address all the requirements from the creditors in order for the accounts to be added to the DMP. These are some of the requirements contained in the creditor logic tool:

| | |
|---|---|
| Accounts | All accounts must be included in program. Sometimes |
| | a number of emergency accounts are allowed |
| Accounts | Creditor will not accept client if creditor is only |
| | creditor to be included in DMP |
| Accounts | To accept account in DMP, name on the account must |
| | match name on proposal |
| Accounts | Creditor will close account upon enrollment of DMP |
| Payment | Account will be dropped after a specified number of |
| Related | missed payment(s) |

Based on the creditors guidelines and the provider's rules, there may be some accounts showing in the credit report that do not qualify for DMP. Therefore, those accounts are pre-filtered into specific types. The following account types are pre-filtered: Secured Accounts, such as Home-Mortgage Loans, Auto Loans, Co-maker/Co-signer, Maker/Signer-secured accounts (car loans), Refinanced/Renewed, Shared Accounts, “On Behalf Of;” Collections, Collections with Zero Balance, Collections Refinanced/Renewed; Student Loans-Federal loans; Zero Balances accounts; Undesignated—not enough information on credit report, Association with Account Terminated. These accounts are filtered and used in the appropriate segments of the system to advise the client.

The accounts that qualify are placed under the DMP Accounts Tab and the accounts that do not qualify are placed under the Non-DMP accounts Tab. Non-DMP Accounts include: Non Auto-matched accounts, Accounts with irresolvable notifications (Account too new), Balances <$100 or <$1 for medical accounts, Null Balances, Null Balance date, Authorized user, Pays 91-120 days, Pays over 120 days, Making regular payments or paid under wage earner plan or similar arrangements, Repossession, Charged off to bad debt, Creditor Rules that produce a irresolvable notification, and any other accounts that the provider designate as a non-DMP account. The following accounts will be placed in DMP Tab: Revolving, Balances >=$100 (Except “medical”; balance >=$1), Individual, Joint, Pays as Agreed, Pays 31-60 days, Pays 61-90 days, Accounts with Informational, Warning and Critical notifications.

Creditor logic also utilizes Business Rules and Universal Notifications, which are explicit statements that define the desired logic of the business/system that must hold true in specified situations in order to maintain the desired state of operations for the business/system. These rules apply to all the accounts to be set up in the DMP regardless of the creditors. For example, account balances cannot be older than 30 days and joint accounts require client and co-client personal information. Universal items are general requirements related to business rules but not related to an individual creditor. The following are some examples of business rules and universal notifications contained in the creditor logic tool:

| | |
|---|---|
| Universal Notifications | Balance must not be older than a specific |
| | number of days. |
| Universal Notifications | Payment must not be lower than the original |
| | payment. |
| Universal Notifications | For joint accounts, a co-client is required. |
| Universal Notifications | Balance must be newer than a specific number |
| | of days and balance amount must be at least |
| | a specified amount. |

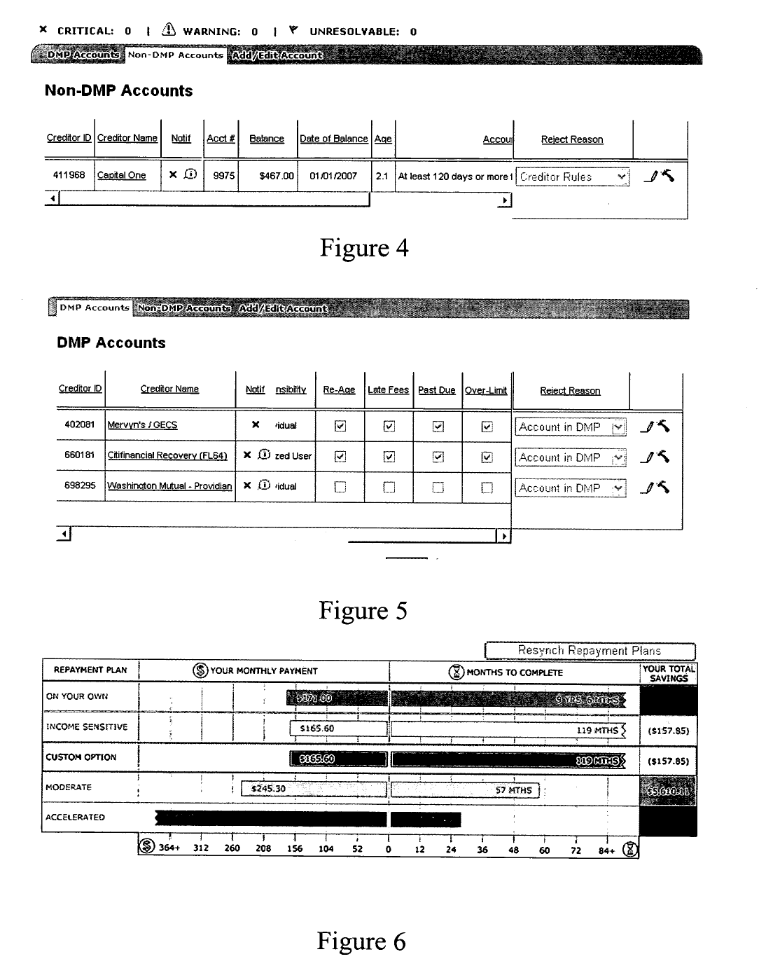

The set of requirements are addressed during the counseling session via notifications as shown in FIG. 4. The notifications are represented by different icons. There are informational notifications, action notifications, warning notifications, critical notifications, and other notifications the provider deems necessary for comprehensive client counseling. Informational items are included to set expectations with client about information the client must know from the creditor when adding the account to the Debt Management Program. For example, original credit card agreements remain in effect while client is on the DMP.

Action items are required to be completed by the client in order for the creditor to allow account to be included in the Debt Management Program. For example, client must remove all “cease and no calls” requests with creditor in order for proposal to be accepted. Warning items can be added to the Debt Management Program only after the creditor's requirements are met. For example, all affiliated accounts must be added into the DMP. Critical items are not eligible to be added to the Debt Management Program because the account does not meet the creditor's requirements. For example, client is only an authorized user, while the client must be the owner of account.

When an account is accepted in the debt management program, creditors provide clients with certain benefits that they would not normally receive on their own. These benefits are intended to assist the client to pay off their debt while in the DMP. For example, stop collection calls, reduce current APR, and waive fees charged to the account as a result of client being behind. Once all the accounts obtained from the credit report are placed under the DMP and Non DMP tabs, Creditor Logic Tool allows clients to review and counselors to provide clients with detailed information per creditor, related to the possible benefits a provider might be able to obtain for the client.

These are some of the benefits contained in the creditor logic tool:

| | |
|---|---|
| Due Date | Creditor will automatically change the due |
| Change | date according to the proposal date |
| Interest Rate - | Creditor offers interest rate adjustment. |
| DMP APR | |
| Late Fees | Creditor will waive late fees |
| Over Limit | Creditor will waive over limit fees |
| Fees | |
| Reage: | Creditor will re-age |

The client is able to evaluate the benefits as shown in FIG. 5. Additionally, counselors may evaluate the benefit screens when counseling the client.

Creditor Logic further provides clients with different repayment plan options according to the payment requirements from creditors. Additionally, the client may be presented with the repayment by counselors providing financial advice. The payment options can include Income Sensitive, Moderate, and Accelerated Plans, as well as other plans the providers may develop for particular types of clients. The system also includes information to the client regarding paying their debt back on their own without the DMP. Clients also have the ability to create a custom repayment plan according to their financial goals and to compare two plans at a time. An example of the options is presented in FIG. 6.

Some of the payment plans include self management (on your own), income sensitive, accelerated, and moderate. In self management, the estimated time for the client to pay off their accounts without a DMP is provided. This algorithm has been based on a 2% monthly payment and a 1.5% monthly interest (18% per annum). Note that this is based on a declining balance, which means the payment gets smaller each month. The monthly payment for this plan is shown as 3% of the initial total balance. The total paid over the life of the plan is estimated based on the initial total balance multiplied by a sliding factor between 3.08 and 3.75 (the higher the initial total balance, the higher the factor). Providers can change these parameters as necessary.

The Income Sensitive plan is based on a fixed monthly payment distributed across the client's accounts, with interest added monthly for each account. When an account pays off, the excess funds are added to the next highest interest account. The monthly payment is determined by creditor and State minimums, plus an appropriate monthly contribution. The number of months on the program is then calculated based on this monthly payment. The total paid is the monthly payment multiplied by the months on the program. The interest paid is the total paid minus the initial total balance minus the total contributions paid (months on program multiplied by contribution). Finally, the plan savings is total paid with no DMP minus total paid for this plan.

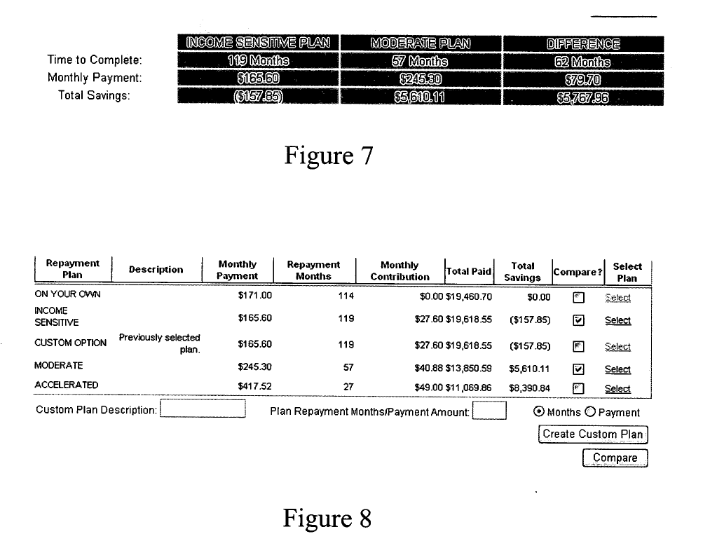

The accelerated plan is based on a duration of 60% of the standard plan or 36 months maximum. The monthly payment is then increased by the appropriate amount to achieve the accelerated payoff. The total paid, interest, and savings, are then calculated similar to the standard plan. The moderate plan is based on a duration of 80% of the standard plan when the standard plan is 60 months or less; otherwise the moderate plan length is set half way between 36 months and the number of months for the standard plan. For example, if the standard plan is 72 months then the moderate plan is 54 months. The client also has the opportunity to compare repayment plans in order to make a decision as shown in FIG. 7.

Additionally, the custom plan gives the client the ability to create their own repayment plan that works best for them, as shown in FIG. 8. The client provides their monthly payment information and the system calculates the amount of months it will take to complete the DMP and recommends whether this is the most optimal plan for the client. The client is then provided with a graphical comparison of the different plan options as shown in FIG. 6. In addition to information specifically directed to the client's situation, the system also provides information to the client to give the client a better understanding of his situation. Such information includes the ability to look up definitions for the terms used by the system. For example, the system may provide a link to a glossary of terms, that the user can then review, one such glossary is provided below:

### GLOSSARY OF TERMS

Annual Percentage Rate: (APR). This is the equivalent to the interest rate. The percentage to the balance charged to the client at a yearly rate.
Account Status: Reflects how your account is being reported by the creditors in your credit report.
Action Notification: Action items are required to be completed by the client in order for the creditor to allow account to be included in the Debt Management Program.
Assignment Process: A Creditor Shell is created in order to research and attempt to match that particular creditor (subscriber) to an existing creditor in the system. If the creditor has not been added to the database then that creditor shell becomes a new creditor account.
Balance: The outstanding amount owed to a creditor on a particular account.
Closing Date: This is the last date of the billing cycle. During this date, the client's statement prints and will provide the client all the transactions and information for the past 28-31 days (This is also known as the billing date, statement date, cycle date).
Creditor Benefits: when an account is accepted in the debt management program, creditors provide clients with certain benefits that they would not normally receive on their own. These benefits are intended to assist the client to pay off their debt while in the DMP. For example: Stop collection calls, reduce current APR, and waive fees charged to the account as a result of client being behind.
Creditor Logic: A combination of the creditor's benefits, creditor requirements, and our business rules to help counselors and clients to set the proper accounts to the DMP when conducting a counseling session.
Creditor Logic Tool: The application created to manage creditor logic. This application will be linked to our Freedom Application via the Benefits Summary Screen.
Creditor Matching: Matching/mapping a creditor subscriber name and code to one in our database.
Creditor Requirements: rules and criteria required from creditors specifically in order for an account to be accepted into the DMP. For example, Citibank™ accounts must be 6 months old; MBNA™ accounts must be 9 months old.
Creditor Shell: a temporary creditor account created in order for research to be conducted to find that particular creditor by name and code.
Critical Notification: Critical items will not be eligible to be added to the Debt Management Program because account does not meet creditor's requirements.
Current Payment: Minimum amount you must pay to the creditor every month to maintain your account status as paid as agreed.
DMP Payment: Amount we are proposing to your creditor in order to pay off your debt faster.
Due Date: Date on which an obligation must be paid.
Finance Charges: The calculation of the APR broken down to dollar amount.
Freedom Application: Our current system utilized to provide services to new and existing clients.
Informational Notification: Informational items are included to set expectations with client about information he/she must know from the creditor when adding the account to the Debt Management Program.
Late Fee: A fee attached to a delinquent account. Creditors may offer the benefit to stop and/or waive late fees.
Mapping/Matching: Pulling creditor subscriber name and code from consumer's credit file and matching it to our creditor database in the system.
Over limit Fee: Fee assessed by the creditor when the balance exceeds the credit limit. Creditors may offer the benefit of stopping and/or waiving over limit fees.
Past Due Amount: The amount owed to the creditor that was unpaid from the previous billing cycle (s).
Past Due Fee: When an account is past due, this causes a fee to be assessed until the account is either re-aged, or the past due amount is satisfied. Creditors may offer the benefit of stopping and/or waiving the past due fees.
Pre-filter of Accounts: The process of looking at all the accounts from a client's credit report and see which ones do not qualify to be included in the Debt Management Program and which ones qualify to be included in the program.
Proposal: Document sent to creditors to make an offer to accept a client into the debt management program. This document contains information such as the client's account information and proposed payment on debt management program.
Re-Age: Benefit provided by creditor to bring an account to a current status, so late fees are stopped and/or eliminated.
Repayment Plan: the system will generate repayment plan options such as income sensitive, moderate, and accelerated. The client may choose one of these plans or create a custom plan to fit their needs.
Savings: Difference in between your current payment and the DMP payment.
Universal Critical Notification: Universal items are general requirements related to business rules not related to an individual creditor. For example: For joint accounts, a co-client is required.
Warning Notification: Warning items can be added to the Debt Management Program only after the creditor's requirements are met.
   The terms described in the previously presented glossary are only exemplary. The provider may change the definitions in accordance with its practices and regulatory requirements as the definitions change. Additionally, the provider may add or delete definitions, as necessary.

The system uses the assigned scores and business logic triggers outlined in Tables 1 and 2 to calculate a primary solution and make a recommendation. In one embodiment of the invention, the system can provide a primary solution suggesting credit counseling or no credit counseling. If the primary solution is credit counseling, the system chooses the highest three attributes and provides a primary solution based upon those attributes. If the primary solution is no, credit counseling, the system chooses the lowest three attributes and provides a primary solution based upon those attributes.

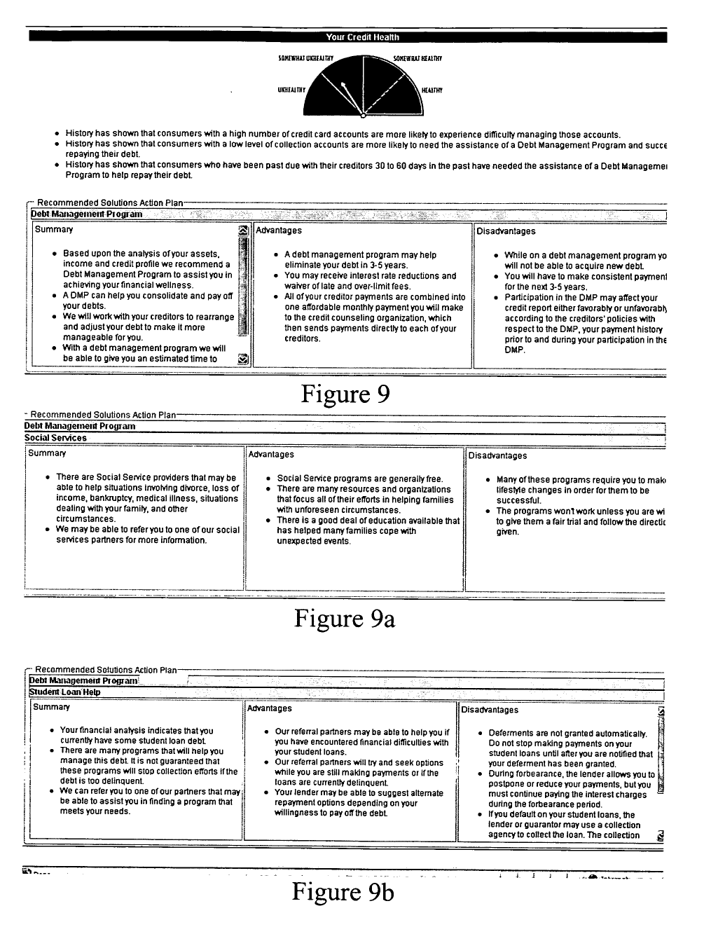

The system provides root cause counseling, primary, secondary, and alternative solutions. The system displays a suggested primary solution for the client as shown in FIG. 9. The first section tells the client whether he or she should enroll in a DMP. The second section provides the client with the positive aspects of enrolling in the DMP including an estimated timeline to eliminate the client's debt. The third section provides some negative issues that the client should consider before enrolling in a DMP. The user can then select the “select DMP” button if he or she decides to enroll in a DMP or get more information.

Secondary and alternative solutions are illustrated in FIGS. 9a and 9b. The list consists of drop down menus that provide positive and negative consequences for each listed course of action. Each course of action and the feedback provided is derived from the business logic triggers previously mentioned. The following explanation provides further details regarding each possible solution. It is understood that the list of solutions provided in this disclosure are not all inclusive, additional solutions may be utilized by different providers utilizing the system.

The primary solutions include money management, debt management, judgment proof, self-help, bankruptcy, workout, among others. A client without any debt items is provided with information about money management. A client with one or more debt items continues to the next step. If the client has a DMP Score and income, the client will be advised to enroll in a regular DMP. If the client has a DMP Score and no income, the client will be advised on alternative solutions. If the Client does not have a DMP Score, the system will determine whether the client meets Judgment Proof requirements. If the client meets Judgment Proof requirements, the system will explain the Judgment Proof option. If the client does not meet the Judgment Proof requirements, the system will evaluate the client's YMP score.

The system determines whether the client has any debt items, such as revolving debt, personal financial installments, or collection items. If the client does not have any debt items, the client's primary solution is Money Management. The program displays information to the client regarding Money Management. For example, the system may state, “The key to money management is being able to understand your day-to-day expenses. Since you currently do not have any unsecured debt, preparing a budget to keep track of your day-to-day expenses may be a good start.” Additionally, the system will provide several advantages and disadvantages based on the information retrieved from the credit report. The system may provide the following Advantages and Disadvantages:

Advantages
1. By managing your expenses, you will gain firsthand knowledge of how to gain control of your finances.
2. You will be able to budget your money and track expenses for yourself.
3. You will experience a sense of accomplishment while successfully improving your spending habits.

Disadvantages
1. Since you have little or no unsecured debt, it may be much harder to take control of these finances on your own.
2. Changing your spending habits may take a long time.
3. Creating a budget or spending plan will not work unless you stick to it.
   The system may select other advantages and disadvantages reflecting the information retrieved from the credit report and asset collection steps.

The system then evaluates the client's DMP score, if the client's score based on the score sheet—as described in Table 1—meets the required DMP score set by the financial institution or provider, the system chooses from two DMP options. If the client does not have any income, the client is categorized as a DMP No Income and counseled on Alternative Solutions as described below. If the client has income, the client is categorized as eligible for a DMP and counseled. Counseling may include among other items the following:
Based upon the analysis of your assets, income and credit profile we recommend a Debt Management Program to assist you in achieving your financial wellness.
A DMP can help you consolidate and pay off your debts.
We will work with your creditors to rearrange and adjust your debt to make it more manageable for you.
With a debt management program, we will be able to give you an estimated time to become debt free.

Advantages
1. A debt management program may help eliminate your debt in 3-5 years.
2. You may receive interest rate reductions and waiver of late and over-limit fees.
3. All of your creditor payments are combined into one affordable monthly payment you will make to the credit counseling organization, which then sends payments directly to each of your creditors.
4. Participation in a DMP helps to eliminate collection calls.
5. Paying off your debts through a credit counseling organization fosters a positive change in your spending behavior.
6. You will receive personalized counseling from a certified financial counselor.

Disadvantages
1. While on a debt management program, you will not be able to acquire new debt.
2. You will have to make consistent payments for the next 3-5 years.
3. Participation in the DMP may affect your credit report either favorably or unfavorably, according to the creditors' policies with respect to the DMP, as well as your payment history prior to and during your participation in the DMP.
4. Most DMPs only address debt that is not backed by collateral. Auto and mortgage loans, for example, generally cannot be included on a DMP.
5. To maintain your agreement with your creditors, you need to review your creditors' statements regularly and contact your creditors and DMP provider immediately if there are any changes to your account.
6. You usually must include all of your creditors in your DMP.

FIG. 9 illustrates an example of a DMP recommendation for a client. The display is entitled “Your Credit Health.” It provides the user with a graphical depiction of their credit situation. In one embodiment of the present invention, such representation is a semicircle divided into four portions: unhealthy, somewhat unhealthy, somewhat healthy, and healthy. Other embodiments of the invention may include bar charts or other depictions that demonstrate the state of the client's financial situation. In other embodiments, there may not be a graphical depiction but a description of the client's situation and in other embodiments there may not be any description of the client's financial situation. As illustrated in FIG. 9, some embodiments will contain general information for the client regarding. Additionally, the system provides a “Recommended Solutions Action Plan” for the client. The title description of the primary solution is provided, e.g., Debt Management Program. The primary solution will give the client a Summary of the solution, its advantages, and disadvantages.

The system also determines whether the client is judgment proof or not. The system utilizes the information obtained through the asset data collection and the credit report to evaluate the client's ability to be judgment proof. The determination is based upon the federal and state legal standards to be considered judgment proof. Some of these standards include that the client's income be derived from the following categories: child support, disability, pensions, social security, veteran's benefits, welfare, worker's compensation, government assistance, and others as prescribed by law. The system also takes into account other state requirements, e.g. Florida, Iowa, Kansas, South Dakota, Texas, and the District of Columbia are the only jurisdictions that allow mortgagors to be deemed judgment proof. Other requirements include that the client must have less than ten creditors on the credit report, the client must not own his or her own business, and the client must not have any student loans. If the required conditions are met, the system provides the client with the judgment proof option. The following example provides the information that can be given to the client:
Judgment Proof means that although you owe some debt, you have no assets and also have limited income (pension/Social Security) to pay that debt. This means that your creditors may not be able to collect on that obligation.

Advantages
1. Being “judgment proof” may help you get rid of unsecured debt without having to file for bankruptcy.
2. Judgment proof helps many consumers with fixed incomes get rid of their unsecured debt and increase their monthly cash flow.

Disadvantages
1. A judgment is only valid for up to 10 years.
2. A judgment does not protect a consumer's assets or home. If you own a home or are thinking of buying a home, judgment proof will not work for you.
3. If you have a business, judgment proof will not be a solution for you. You run the risk of losing your business.
4. Judgment proof status provides you with an extension to pay what is owed, but it does not eliminate the debt.
5. Judgment proof status is ultimately the judge's decision and it is often hard to accurately predict who will qualify.
6. Remaining income and assets that are determined to be judgment proof are determined by state law.
7. It is important to remember that the “judgment proof” state is not a permanent condition, but a temporary legal status. You are “judgment proof” only as long as your financial condition stays the same or gets worse. If your financial condition improves, creditors who have a judgment against you may still be able to collect money from you in the future.
8. The judgment will show up on your credit report.
9. Judgment proof does not protect against student loan debt.
10. If you plan on purchasing a home or going back to work during that time the creditor has the right to enforce the judgment to try to recover their money.
   If the client does not qualify for Judgment Proof, the option is not provided. In one embodiment of the present invention, the system evaluates whether the client qualifies for the self-help YMP. In other embodiments, other programs may be available.

One parameter that may be used to determine whether a client qualifies for a specific program is the debt-to-income ratio. The system is given a specific debt-to-income ratio, e.g. 42%. If the client's debt-to-income ratio is below the indicated ratio, the client is provided with that specific program as one of the primary solutions. In one embodiment of the present invention, the program is called Self Help YMP. If the client's debt to income ration is above the indicated ratio, the client may be presented with a different alternative. When the client's debt-to-income ratio is below the indicated ration following information is presented:
Based on the analysis of your income, assets, and credit report you may be able to manage your debts on your own.
Your income compared to your monthly debt expense indicates that you have the ability to gain control of your finances on your own.
With the help of our educational information, we will be sending you should be able to develop a budget and debt repayment plan to assist you.

Advantages
1. By doing it yourself you will gain firsthand knowledge of how to get out of debt.
2. You will be able to budget your money and track expenses for yourself.
3. You will experience a sense of accomplishment once you are completely out of debt.
4. You will successfully improve your spending habits.

Disadvantages
1. Getting out of debt on your own can be much harder than it seems.
2. Changing a spending habit can take a long time.
3. You may not be willing to give up your credit cards when trying to get out of debt.
4. Budgeting does not work unless you stick to it.
   On the other hand, if the client's debt-to-income ratio is greater than the ratio indicated, e.g. 42%, the system checks additional criterion to make a determination.

The system evaluates the following criterion in making a determination, when the ratio is greater than that indicated:
a. The client's debt consists of 75% of collection, Pay Day Loans, and/or Title Loans.
b. The client has more than two debt items (revolving debt, Personal Finance Installment, or collection item).
c. The client's debt is greater than $5,000 in revolving debt, Pay Day Loans, and Title Loans.
d. The client has not filed for Bankruptcy in the last 6 years.
   If a, b, c, and d hold true, the system may recommend Bankruptcy as the primary solution for the client. If one or more of the requirements are not met, the system provides Workout as the primary solution. The system can also provide other solutions based upon the debt-to-income ratio and other parameters.

When the system determines that Bankruptcy is the primary solution, the following information is given to the client:
Based on the analysis of your assets and the severity of your current credit standing we recommend you speak with an attorney about your available options.
Bankruptcy may offer some resolution to your financial worries, so you can start rebuilding your financial wellness.

Advantages
1. Bankruptcy protection may offer you a fresh financial start.
2. In Chapter 7 Bankruptcy (Liquidation), your assets are sold and the proceeds are used to pay off your debts, offering you a fresh financial start after your obligations are discharged.
3. Under Chapter 13 Bankruptcy (Reorganization), you are able to pay off your debts through a court-arranged repayment plan and still keep your assets.
4. Under Chapter 7, you may be allowed by state law to keep certain exempt assets, such as your house. State law varies widely in terms of the assets it exempts from liquidation.
5. You can keep assets used as collateral on a loan by reaffirming the collateralized debt, which is a commitment to repay that specific debt even after you have been discharged from bankruptcy. You will, however, lose that asset if you are unable to meet your repayment obligations.
6. Collection efforts from your creditors must stop as soon as you file for bankruptcy.
7. You cannot be fired from your job if you file for bankruptcy.
8. Retirement funds also are excluded in a bankruptcy proceeding.
9. Before filing for bankruptcy, you are required to participate in a credit-counseling program that will help you assess whether or not bankruptcy is a feasible option for you. If you do file for bankruptcy, you are required to take a Financial Education class before your debts are officially discharged by the court.

Disadvantages
1. A bankruptcy may stay on your credit for up to ten years.
2. After you file for bankruptcy, new credit will be difficult to obtain. Once obtained you will most likely pay a much higher interest rate.
3. There are still substantial “non-dischargeable” debts that are not forgiven in any type of bankruptcy, such as:
   Income taxes, property taxes, payroll taxes, sales tax.
   Child support.
   Alimony or spousal maintenance.
   Student loans.
   Fines, penalties, and restitution ordered by the courts; court fees; debts due to driving while intoxicated.
   Any debts that were incurred due to fraud on your part.
   Any debts that were ruled not dischargeable in a previous bankruptcy.
   Any debts you forget to list on your bankruptcy petition.
   Once a person has filed Chapter 7 bankruptcy, he or she is prohibited from declaring bankruptcy for six years.

Another program available in one embodiment of the present invention is a “workout”. This option is available for clients whose debt-to-income ratio is greater than 42%, but fail to meet one or more of the Bankruptcy criterion:
a. The client's debt consists of 75% of collection, Pay Day Loans, and/or Title Loans.
b. The client has more than two debt items (revolving debt, Personal Finance Installment, or collection item).
c. The client's debt is greater than $5,000 in revolving debt, Pay Day Loans, and Title Loans.
d. The client has not filed for Bankruptcy in the last 6 years.
   Clients eligible for the workout are presented with the following information:
We do not believe that a Debt Management Program will provide you the benefits necessary to successfully repay your debt. Based on the analysis of your income, assets, and credit information, we feel a solution such as a Workout may be the best option.
A Workout is an alternative to a traditional Debt Management Program. It is an attorney-assisted program in which the attorney will negotiate with your creditors on your behalf. Although Workouts help with debt that is past due, attorneys also work with clients that have never been late on their accounts.
A workout may also assist you with other secured debts such as a mortgage or car payment and due to the attorney representation, this program, in many instances, can also stop creditor harassment calls.

Advantages
1. A Workout is an alternative to a Debt Management Program that helps you avoid the financial and emotional implications of a bankruptcy.
2. A Workout can help you make arrangements to pay less than what is owed and can help you settle the debt in full or can help you extend the amount of time you have to repay your total debt to reduce your monthly expenses.
3. A Workout may even help you with your secured mortgage or car expenses and can help you retain many assets you would have to give up in a bankruptcy.

Disadvantages
1. If a Workout successfully reduces a large portion of your unsecured debt, you may have to pay taxes on the amount that was reduced.
2. A Workout is sometimes reported almost as unfavorably as a bankruptcy.
3. In most Workouts, there will be attorneys' fees that need to be paid. Each Workout is different so asking questions about the costs to handle your particular situation is highly recommended.
   The previous examples can change depending on the situation of the client and other factors that the financial services provider may deem necessary. The workout can include a number of alternative solutions, as explained below, depending on the client's specific situation.

The bankruptcy and workout options are also available for clients that have more than two debt items, more than five thousand dollars in revolving debt, Pay Day Loans, and Title Loans, and who have not filed bankruptcy in six years. A client that meets all the requirements is counseled in bankruptcy and a client that does not meet all the requirements is counseled in workout.

In one embodiment of the present invention, the previously discussed solutions constitute the primary solution provided to the client. Other embodiments may contain additional primary solutions or they may utilize fewer primary solutions. In some cases the financial institution or provider utilizing the present invention may utilize the alternate solutions described below as a primary solution, or the primary solutions previously described as alternate solutions. In yet other cases, the system may only provide primary solutions or it may only provide alternate solutions.

One embodiment of the present invention provides alternative solutions. Alternative Solutions can be beneficial to the consumer based upon their situation. They are alternatives to the Primary Solution because they are based on a client's assets and are usually short-term fixes. These alternative solutions can be presented to the client even if the financial provider does not ultimately handle alternative solutions for the client. The consumer needs to leverage his or her assets in order to accomplish the Alternative Solution. For example, the consumer may be able to take a loan against their 401K plan in order to pay off some debt and pay it back to themselves through their 401K plan, which is a better option than paying high interest rates on their credit cards. The Alternative Solutions are calculated based on business triggers listed under each of the solutions. Some alternative solutions may include: 401K benefits, Liquidating Assets to Pay off Your Debt, Home Equity Line of Credit (HELOC), Second Mortgage, Home Equity Loan, Reverse Mortgage, Lump Sum Debt Settlement, and other solutions.

If the client has a 401K as determined in the asset collection step, the system presents the client with an alternative solution that utilizes vested funds in the client's 401K to pay the client's revolving debt. The client is first asked if he or she has a 401k loan. If the answer is yes, the system does not provide the 401K alternative solution. If the answer is no, the system calculates the amount of money that the client can borrow against his or her 401K to pay the debt. In calculating the amount of money that the client can borrow the system estimates that the client is 20% vested for each year of employment. For example, if a client is employed for three years, the total amount vested is 60% (20% for each year). This means that if the client's balance were $10,000 then the vested amount would be $6,000.

Once the system determines the amount vested, it compares it to the client's debt and determines whether the client has sufficient funds vested in the 401K plan to take out a loan and pay all or portion of the clients revolving debt. If 50% of the client's vested 401K balance is greater than the revolving debt, the following message is displayed in the alternative solution window: “According to the data provided you have enough funds in your 401K plan to take out a loan and pay off all of your revolving debt.” If 50% of the client's vested 401K balance is between 50% and 99% of the client's total revolving debt the following message is displayed in the alternative solutions window: “According to the data provided you have enough funds available in your 401K plan to take out a loan and pay off over half of your total revolving debt.”

Additionally the system provides information to the client regarding the utilization of 401K funds for the purpose of reducing revolving debt. The system can, for example, provide the following information:
According to your financial analysis, you may be able to borrow or withdraw money from your 401K plan to help you pay your debts.
Using your 401K to pay down debt is usually not a recommended solution because it uses your retirement funds. This is considered a short-term solution.
It is strongly advised that you speak to your 401K provider prior to making such a decision.

Additional Education:
There are times when you need cash, and you may think there are no viable options other than to tap into your 401k retirement plan, which is designed to provide for your later years. You can borrow up to 50% of your vested account balance or $50,000, whichever is less. If you have taken out a 401k loan in the previous twelve months, you will only be able to borrow 50% of your vested account balance up to $50,000, less the outstanding balance on the previous loan. You usually have a maximum of five years to repay the loan, unless you are borrowing for a first home, which allows a longer payback over 30 years. The government allows plan administrators to offer 401k loans to participants. However, as with most financial issues, it is not as simple as it sounds. In fact, for most people, borrowing from a 401k is not the best solution.
The primary benefit of 401k loans is that the proceeds are not subject to taxes or the 10% penalty fee except in the event of default. The government does not set guidelines or restrictions on the uses for 401k loans. Many employers, however, do. These can include minimum loan balances (usually $1,000) and the number of loans outstanding at any time in order to reduce administrative costs.

It is probably not wise to take out a 401k plan loan when:
You are planning to leave your job within the next couple of years.
There is a chance you will lose your job due to a company restructuring.
You are nearing retirement.
You can obtain the funds from other sources.
You cannot continue to make regular contributions to your plan.
You cannot pay off the loan right away if you are laid off or change jobs.
You need the loan to meet everyday living expenses.
You want the money to purchase some luxury item or pay for a vacation.
There is a basic trade-off between how much you expect your money to earn in the 401k plan if you don't borrow the money and how much you will earn in the plan by time of retirement if you do take out the loan.
401K loans are not tax-sheltered money. Whether you repay the 401k loan out of your salary or from a bank account, those payments are all made back into the 401k with after-tax dollars.
Another point often overlooked is that you will be taxed twice on the loan amount. The money you borrow is money that you contributed before taxes. However, you pay it back with after-tax money (unlike your contributions, it is not deducted from your paycheck before taxes). When you withdraw the money at retirement, it will be taxed again.
If you lose or leave your job before the loan is paid off, the balance of the loan usually must be paid in full at termination, or it will be treated as a distribution. “Distributed” 401k money triggers a federal tax penalty of 10% for early withdrawal if you are less than age 59½, and you will have to pay federal income taxes on the distributed amount. If you are in a 25% tax bracket, the taxes plus penalty means you will have to surrender 35% of your balance. If you live in a state with income tax, that will be charged as well so you could lose as much as 50% to state and federal income taxes. Check with your plan administrator for specific details.
If you have a financial emergency, and your only choices are borrowing from your 401k plan or withdrawing the money in a hardship withdrawal before age 59½, make sure you understand the advantages and disadvantages to both.
Under a 401k hardship plan, you may withdrawal only if: (1) the withdrawal is due to an immediate and heavy financial need; (2) the withdrawal must be necessary to satisfy that need. All 401k hardship withdrawals are subject to taxes and most are subject to a 10% penalty. Plans prohibit you from contributing to your account for six months after you make a hardship withdrawal, which may deprive you of receiving company matching funds.
The following items are considered by the IRS as acceptable reasons for a hardship withdrawal:
1. Un-reimbursed medical expenses for you, your spouse, or dependents.
2. Purchase of an employee's principal residence.
3. Payment of college tuition and related educational costs such as room and board for the next 12 months for you, your spouse, dependents, or children who are no longer dependents.
4. Payments necessary to prevent eviction of you from your home, or foreclosure on the mortgage of your principal residence.
5. Funeral expenses.
You may qualify to take a penalty-free withdrawal if you meet one of the following exceptions:
You become totally disabled.
You are in debt for medical expenses that exceed 7.5% of your adjusted gross income.
You are required by court order to give the money to your divorced spouse, a child, or a dependent.
You are separated from service (through permanent layoff, termination, quitting or taking early retirement) in the year you turn 55, or later.
You are separated from service and you have set up a payment schedule to withdraw money in substantially equal amounts over the course of your life expectancy. (Once you begin taking this kind of distribution you are required to continue for five years or until you reach age 59½, whichever is longer.)
Check with your Human Resources department if you are not sure if your plan allows hardship withdrawal. As with loans, your employer must adhere to some very strict and detailed guidelines.

Advantages
1. There is usually no qualification necessary to get your loan; however, there may be a small qualification process for a 401K withdrawal.
2. There is no review of your credit report (no “pulling your credit”) to get a loan.
3. When repaying back the loan you are paying the interest back to yourself. If you are taking a 401K hardship then the money does not need to be paid back.
4. Paying the loan back is relatively easy and is usually deducted from your paycheck.
5. Depending on your situation, you may be able to also take out a hardship withdrawal.

Disadvantages
1. It is generally not recommended that you take money out of your retirement or savings accounts. If taking a 401k withdrawal you must consider the implications of loosing most if not all of your retirement funds.
2. By taking money out of your 401k account, you reduce the benefits of tax-free compounding, which are key to building up a substantial balance. Experts recommend trying other alternatives first, including lifestyle changes, to reduce your spending.
3. If you lose or leave your job before the loan is paid off, the balance of the loan usually must be paid in full at termination, or it will be treated as a distribution. “Distributed” 401k money triggers a federal tax penalty of 10% for early withdrawal if you are less than age 59½, and you will have to pay federal income taxes on the distributed amount. If you are in a 2% tax bracket, the taxes plus penalty means you will have to surrender 35% of your balance. If you live in a state with an income tax that will be charged, too, meaning you could lose as much as 50% to state and federal income taxes. Check with your plan administrator for specific details.
4. There is a basic trade-off between how much you expect your money to earn in the 401k plan if you do not borrow the money and how much you will earn in the plan by time of retirement if you do take out the loan. This is especially true if your employer matches your contributions. In order to get the maximum benefit from your 401k, you should always contribute enough to get the maximum employer match.
5. 401K loans are not tax-sheltered money. Whether you repay the 401(k) loan with your salary or from a bank account, those payments are all made back into the 401(k) with after-tax dollars.
6. Another point often overlooked is that you will be taxed twice on the loan amount. The money you borrow is money that you contributed before taxes. However, you pay it back with after-tax money (unlike your contributions, it is not deducted from your paycheck before taxes). When you withdraw the money at retirement, it will be taxed again.
7. If you leave your job, you need to repay any loan balance. You might have to turn down a job offer with a different company because you cannot repay the 401k loan. You might have the whole loan due just when you have lost your job to downsizing.
8. If you do not pay the loan back, you will pay a 10% early withdrawal penalty plus ordinary income taxes on the “distribution.”
9. If taking a 401K hardship withdrawal, you are subject to taxes and most are subject to the 10% penalty. This means that a $10,000 withdrawal can result in not only significantly less cash in your pocket (possibly as little as $6,500 or $7,500).
10. Taking out a 401k hardship withdrawal denies you the tax-deferred growth that could have been generated by the amount withdrawn.
11. You cannot pay back the 401k hardship withdrawal proceeds to the account once the disbursement has been made, losing you that asset and the deferred growth on that asset when you are ready for retirement.
   The information provided to the client may change reflecting any changes in the availability and parameters available to clients selecting 401K loans. The above described language is only an example and each financial provider may provide additional educational text or remove any of the information provided above. Furthermore, the text provided will change as laws and regulations are modified.

Another alternative method is the liquidation of assets to pay off the client's debt. Liquid assets such as cash (from checking and savings accounts and any other source), bonds, stocks, certificates of deposit (CDs), vested amounts of 401Ks, HELOCs and home equity payments. This solution is provided only if assets are equal to at least 70% of client's revolving debt balances. The percentage of assets v. debt balances is displayed for the user and the following information is provided:

Summary Content:
According to your financial analysis, you may be able to eliminate your debt by using your savings and/or your other assets.
Using your savings to pay off debt is an option. However, it may reduce your ability to be prepared if an unexpected emergency occurs.
Liquidating your assets is considered a short-term solution and it is strongly recommended that you look at all of your options prior to making a decision.

Additional Education:
There are various options that people with too much debt can use to bring their financial lives back into control. One option is to sell or liquidate (cashing out assets such as a 401K) available assets to pay off the debt that is impacting you the most. Having admitted the financial problems to yourself and your loved ones, having stopped taking on more debt, and focused on paying off the debts, you can look at your situation and see if there are any assets, you could cash in or sell to raise funds.
You should first look at your unused or unnecessary assets. Perhaps you have an extra vehicle or some recreational equipment such as a boat that could be sold to pay down your debt.
Do you have funds in a savings account that might be used to pay debt? There is no point in paying 18 percent interest on a credit card debt while you have money in a savings account earning only 2 percent.
If you can no longer afford to pay your mortgage, perhaps there is enough equity that you would be able to pay off some debts after you pay off all your mortgage/lien obligations.
One asset you may not want to touch is a retirement account at your place of employment. Retirement savings is to be used only for your future financial security, so you should never borrow those funds to repay consumer debts unless it is an absolute necessity. (Retirement funds also are excluded in bankruptcy proceedings.)
If you have identified possible assets, use the following steps to decide whether or not you should cash in or sell the asset to reduce your debt: The primary benefit of selling assets to pay off debt is the resulting lower balances on those debts and thus the lower monthly payments and reduced interest charges.

Identify the asset: Example: Motorcycle

| | |
|---|---|
| Assess the dollar value: | $5,500 |
| Calculate dollar amount after the loan is paid off: | $3,700 |
| Identify total debt: | $3,500 |
| Calculate the difference | $200 |
| Percentage of debt to be paid with the asset | 95% |

If your assets pay off at least 80% of your debt you should consider using the asset to pay your debt.

Advantages
1. You get rid of your debt.
2. You stop accruing interest on your debt.
3. You stop collection efforts from your creditors.

Disadvantages
1. You may not be able to cover an unexpected emergency if you reduce or eliminate your savings. Many financial advisors suggest that you stay away from taking your savings to pay off debt unless it is absolutely necessary.
2. If you lose your source of income and do not have savings to fall back on you may not be able to cover major expenses such as your car payment and/or mortgage.
3. By liquidating your 401K and other investment assets, you may be subject to a penalty fee of up to 10%. In addition, you must pay taxes when the monies are withdrawn prior to the 59½ age requirement.
4. You may not have enough equity in the asset to make it worth selling.
5. If sold, you obviously lose use of that asset; your balance sheet and net worth are negatively impacted.
   The information provided to the client may change reflecting any changes in the parameters available to clients selecting asset liquidation solution. The above described language is only an example and each financial provider may provide additional educational text or remove any of the information provided above.

Another solution presented to the client can be the Home Equity Line of Credit (HELOC). The system determines whether the client has a home loan and sufficient equity to obtain a loan. The financial institution or provider may select a minimum debt balance to allow a client to obtain a HELOC. The system first calculates the credit line amount that the client may borrow. The parameters used are based on the provider's standards or other guidelines. In one embodiment of the present invention, the system calculates a 90% Loan-To Value (LTV) of the client's approximate market value of the property and subtracts from that value the estimated mortgage balance. If the remainder is greater than the client's total revolving debt, the system suggests a HELOC as an alternative solution.

In one embodiment of the present invention, further calculations are then conducted to determine the client's payments in an interest only loan option. The first step in this process is to determine the interest rate that will be applied to the loan. If the client's credit score, as determined either by the credit bureaus or the system's score sheets, is greater than 700 the interest rate is 8.50%. If the client's credit score is less than 699 but greater than 650, the interest rate is 9.50%. If client's credit score is less than 649 but greater than 600, the interest rate is 11.50%. If the client's credit score is under 599, the system does not recommend this solution. After determining the interest rate, the system multiplies the amount of revolving debt by the interest rate. The result is then divided by twelve for the resulting monthly payment.

For example: A client has a home with a value of $240,000 and a mortgage balance of $163,000 and the client's total revolving debt is $25,000. The Home Value is multiplied by 90% (LTV)=($240,000*90%)=$216,000. Next, the system subtracts the balance on the mortgage from the calculated LTV amount: $216,000 (90% LTV)−$163,000 (Mortgage Balance)=$53,000 (available for line of credit). Total revolving debt ($25,000) is less than the total available for the line of credit loan ($53,000) and, as a result, the client cant utilized the line of credit loan to pay off all revolving debt. The system then calculates the amount of interest to be paid on the line of credit based upon the credit score of the client. If the client's credit score is 700 or higher, multiply $25,000 by 8.5% (divide interest by 12)=$177.08 (estimated line of credit payment). If the client has a credit score between 650 and 699 multiply $25,000 by 9.5% (divide interest by 12)=$197.92. If the client has a credit score between 600 and 649 multiply $25,000 by 11.5% (divide interest by 12)=$239.58.

A client's total approximate interest payments are also calculated. The system takes the client's estimated line of credit payment and multiplies it by 180 months and 360 months (15 year and 30 year loan) and subtracts it from the original loan amount. In the previous example, using the client with a credit score higher than 700, the total interest for the two different term loans would be $3,178.40 for the fifteen year loan ($177.08*180) or $63,748.80 for the thirty year loan ($177.08*360).

Using these calculations, the system presents HELOC solution to the client. The solution provides specific data gathered from the previously calculated values. In the example described above, the information provided to the consumer can state: “An equity line of credit will take you 15 to 30 years to pay off and the amount in interest you will be paying will be approximately $31,874.40 to $63,748.80.” In addition to specific information, the following information will be provided to the client:

Summary Content:
According to the financial analysis of your assets and credit, you may be able to reduce your debt by using the equity in your home.
Using your equity to pay off debt is an option. However, it is a short-term fix that may put your home at risk, significantly increase the total debt paid, and does not help you modify your spending behavior.

Additional Education:
A home equity line of credit (HELOC) is a form of revolving credit in which your home serves as collateral. In determining your actual credit limit, the lender will also consider your ability to repay by looking at your income, debts, and other financial obligations as well as your credit history. Once approved for a home equity line of credit, you will most likely be able to borrow up to your credit limit whenever you want. Typically, you will use special checks to draw on your credit line. Under some plans, borrowers can use a credit card or other means to draw on the line. Because the home is likely to be your largest asset, you should use this credit line only for major expense items such as education, home improvements, or medical bills, not for day-to-day expenses.
With a HELOC, you will be approved for a specific amount of credit, which becomes your credit limit, the maximum amount you may borrow at any one time under the plan. Many lenders set the credit limit on a home equity line by taking a percentage, such as 75%, of the home's appraised value and subtracting from that the balance owed on the existing mortgage. There may be limitations on how you use the line. Some plans may require you to borrow a minimum amount each time you draw on the line (for example, $300) and to keep a minimum amount outstanding. Some plans may also require that you take an initial advance when the credit line is set up.
By using the equity in your home, you may qualify for a sizable amount of credit, available for use when and how you please, at an interest rate that is relatively low. Furthermore, you may be allowed to deduct the interest because the debt is secured by your home.
Many home equity plans set a fixed period during which you can borrow money, such as 10 years. At the end of this “draw period,” you may be allowed to renew the credit line. If your plan does not allow renewals, you will not be able to borrow additional money once the period has ended. Some plans may call for payment in full of any outstanding balance at the end of the period. Others may allow repayment over a fixed period (the “repayment period”), for example, 10 years.
Regardless of the minimum required payment, you may choose to pay more and many lenders offer a choice of payment options. Many consumers choose to pay down the principal regularly as they do with other loans. For example, if you use your line to buy a car, you may want to pay it off as you would a typical car loan.
Interest rates for loans differ, so it pays to check with several lenders for the lowest rate. Compare the annual percentage rate (APR), which indicates the cost of credit on a yearly basis. Be aware, however, that the advertised APR for home equity credit lines is based on interest alone. For a true comparison of credit costs, compare other charges, such as points and closing costs that will add to the cost of your home equity loan. This is especially important if you are comparing a home equity credit line with a traditional installment (or second) mortgage, where the APR includes the total credit costs for the loan.
Most lenders cite the interest rate you will pay as the value of the index at a particular time plus a “margin,” such as 2 percentage points. Because the cost of borrowing is tied directly to the value of the index, it is important to find out which index is used, how often the value of the index changes, and how high it has risen in the past as well as the amount of the margin.
Loans with a large final (balloon) payment may lead you to borrow more money just to pay off this debt, or they may put your home in jeopardy if you cannot qualify for refinancing. Moreover, if you sell your home, most plans require you to pay off your credit line at that time. In addition, because home equity loans give you relatively easy access to cash, you might find you borrow money too freely. Taking an equity line of credit or second mortgage to pay off your accounts does not change your spending habits. This means that you may eventually fall back into high unsecured debt while also putting your home at risk.
If you are thinking about a home equity line of credit, you might also want to consider a traditional second mortgage loan. A second mortgage provides you with a fixed amount of money repayable over a fixed period. In most cases, the payment schedule calls for equal payments that will pay off the entire loan within the loan period.

Advantages
1. You will find most loans come with variable interest rates, and some feature attractive low introductory rates (a select few come with fixed rates). You also may find most loans have large one-time upfront fees, others have closing costs, and some have continuing costs, such as annual fees. You can find loans with large balloon payments at the end of the loan, and others with no balloons but with higher monthly payments.
2. Based on your potential equity in your home you may be able to qualify for a “$” equity line of credit to pay off your debts. Based on the industry average that would be an approximate payment of “$” per month.
3. Most financial institutions will not charge any closing costs for clients seeking HELOC. However, there is usually a minimal processing fee.

Disadvantages
1. Failure to repay the amounts you have borrowed, plus interest, could mean the loss of your home.
2. An equity loan may take you 15 to over 30 years to pay off.
3. You reduce the amount of equity in your home that is available towards the purchase of a new home.
4. Using a HELOC or second mortgage to pay off debt does not change your spending habits. This means that you may eventually fall back into high unsecured debt while also putting your home at risk.
5. If you sell your home, most plans require you to pay off your credit line at that time.
   The above described language is only an example and each financial provider may provide additional educational text or remove any of the information provided above. In addition, the parameters used in each calculation may be tailored to the specific service provider standards and as required by law. For example, the interest rates may change as they customarily do in lending programs.

A second mortgage or home equity loan can be presented to the client as alternative solutions. A provider may set different parameters for the availability of these options. In one embodiment of the present invention, the client must have a minimum revolving debt balance of $6,000.00 and the available loan amount must be sufficient to cover the total amount of the revolving debt. The system calculates the LTV in the same manner described previously for the HELOC solution, however, the factor is 95% (as opposed to 90% used in HELOC). The system then calculates the available loan amount by subtracting the mortgage balance from the LTV. If the available loan amount is greater than the total revolving debt, the system presents the client with this solution. The loan calculation can then be sent to a third party for feedback and audit purposes. Once the loan calculation is confirmed, the system determines the interest rate that the client is to be charged. As with the HELOC solution, the interest rate can vary and can be based upon the client's credit score or BrightScore. If the client's credit score is greater than 700 the interest rate is 10% (in some instances the calculation is not exactly 10%, the factor can be, for example, 0.096502). If the client's credit score is between 699 but and 650 the interest rate is 11.50% (or 0.106642). If client's credit score is between 649 and 600, the interest rate is 13.50% (or 0.120738). If under 599, the system does not recommend the solution. In some embodiments of the present invention, the interest rate is not based upon the client's credit score. As with the HELOC solution, after calculating the interest, the system provides the client with the total monthly payments, monthly interest, yearly interest, and total interest over the life of the loan. In addition, the system provides the following information to the client.

Summary Content:
According to the financial analysis of your assets and credit, you may be able to reduce your debt by using the equity in your home.
Using your equity to pay off debt is an option. However, it is a short-term fix that may put your home at risk, significantly increase the total debt paid, and does not help you modify your spending behavior.

Additional Education:
A second mortgage or home equity loan is a form of secured credit in which your home serves as collateral. In determining your actual credit limit, the lender will also consider your ability to repay, by looking at your income, debts, and other financial obligations as well as your credit history. Unlike a Home Equity Line of Credit, you will not receive checks to use on your loan. The loan will have a set payment usually from 10 to 20 years and you will be able to payoff the debt in a specified amount of time.
With a second mortgage, you will be approved for a specific amount usually enough to pay off your revolving debt obligations. This amount is usually based on your Loan-to-Value amount. A loan to value is the amount a bank is willing to let you borrow based on the equity of your home. Many lenders set the credit limit on a second mortgage by taking a percentage, such as 95%, of the home's appraised value and subtracting from that the balance owed on the existing mortgage.
By using the equity in your home, you may qualify for a sizable amount of credit. Furthermore, you may be allowed to deduct the interest because the debt is secured by your home.
Many home equity plans set a fixed period for the loan term, such as 10 years. Regardless of the minimum required payment, you may choose to pay more, and many lenders offer a choice of payment options.
Interest rates for loans differ, so it pays to check with several lenders for the lowest rate. Compare the annual percentage rate (APR), which indicates the cost of credit on a yearly basis. For a true comparison of credit costs, compare other charges, such as points and closing costs that will add to the cost of your loan. This is especially important if you are comparing your second mortgage to a home equity credit line of credit.
If you are thinking about a second mortgage, understand that it provides you with a fixed amount of money repayable over a fixed period. In most cases, the payment schedule calls for equal payments that will pay off the entire loan within the loan period so there are no surprises.

Advantages
1. You will find most loans come with a fixed interest rate (a select few come with variable rates). You will have a fixed payment for a set amount of time.
2. Most of the time, you will be able to pay off all of your revolving debt and save a good amount on monthly payments.
3. Based on your potential equity in your home you may be able to qualify for a “$” second to pay off your debts. Based on the industry average that would be an approximate payment of “$” per month.

Disadvantages
1. Failure to repay the amounts you have borrowed, plus interest, could mean the loss of your home.
2. An equity loan will take you 10 to 20 years to pay off and the amount in interest rate you will be paying over the life of the loan may be significantly more than you currently owe on your revolving debts.
b 3. Most financial institutions will charge closing costs on second mortgages.
4. Using a second mortgage to pay off your debt does not change your spending habits. This means that you may eventually fall back into high unsecured debt while also putting your home at risk.
5. If you sell your home, you will have to pay off your second mortgage at that time.
6. You reduce the amount of equity in your home that is available towards the purchase of a new home.
   The above described language is only an example and financial providers may utilize additional educational text or remove any of the information provided above. In addition, the parameters used in each calculation may be tailored to the specific service provider standards and as required by law. For example, the interest rates may change as they customarily do in lending programs.

The reverse mortgage solution is available for those clients who are over sixty two (62) years of age, own their own home, and have over 50% equity in their home. For example, if the estimated home value is $100,000 and the mortgage balance is $45,000, the client has $55,000 in equity or 55% of the value and qualifies for this solution. The client who qualifies is presented with the following information:

Summary Content:
Your financial analysis indicates that you may be able to qualify for a Reverse Mortgage, which is a loan against your home's equity.
Reverse mortgages are generally used when a consumer is in need of additional cash. It is not always recommended because the payments are made from the equity of your home reducing the amount of your assets. It is strongly recommended that you seek the advice of your lender or attorney before making such a decision.

Additional Education:
A “reverse” mortgage is a loan against your home's equity that you do not have to pay back for as long as you live there. Typically, nothing has to be paid back until you permanently move out of your home. To be eligible for most reverse mortgages, you must own your home and be 62 years of age or older.
The cash you get from a reverse mortgage can be paid to you in several ways:
   . All at once, in a single lump sum of cash
   As a regular monthly cash advance
   As a “credit line” account that lets you decide when and how much of your available cash is paid to you.
   As a combination of these payment methods.

Loan Features
Reverse mortgage loan advances are not taxable, and generally do not affect Social Security or Medicare benefits. You retain the title to your home and do not have to make monthly repayments. The loan must be repaid when the last surviving borrower dies, sells the home, or no longer lives in the home as a principal residence. As you consider a reverse mortgage, be aware that:
Lenders generally charge fees and other closing costs. They also may charge servicing fees during the term of the mortgage. The lender generally sets these fees and costs.
The amount you owe on a reverse mortgage generally grows over time. Interest is charged on the outstanding balance and added to the amount you owe each month. This means your total debt increases over time as loan funds are advanced to you and interest accrues on the loan.
Reverse mortgages may have fixed or variable rates. Most have variable rates that are tied to a financial index and will likely change according to market conditions.
Reverse mortgages can use up all or some of the equity in your home, leaving fewer assets for you and your heirs. A “non-recourse” clause, found in most reverse mortgages, prevents either you or your estate from owing more than the value of your home when the loan is repaid.
Because you retain title to your home, you remain responsible for property taxes, insurance, utilities, fuel, maintenance, and other expenses. Therefore, for example, if you do not pay property taxes or maintain homeowner's insurance, you risk the loan becoming due and payable.
Interest on reverse mortgages is not deductible on income tax returns until the loan is paid off in part or whole.

There are three basic types of reverse mortgage:
Single-purpose reverse mortgages, which are offered by some state and local government agencies and nonprofit organizations. Single-purpose reverse mortgages generally have very low costs. But they are not available everywhere, and they only can be used for one purpose specified by the government or nonprofit lender, for example, to pay for home repairs, improvements, or property taxes. In most cases, you can qualify for these loans only if your income is low or moderate.
Federally insured reverse mortgages, which are known as Home Equity Conversion Mortgages (HECMs), and are backed by the U.S. Department of Housing and Urban Development (HUD). Before applying for a HECM, you must meet with a counselor from an independent government-approved housing counseling agency. The counselor must explain the loan's costs, financial implications, and alternatives. The amount of money you can borrow with a HECM or proprietary reverse mortgage depends on several factors, including your age, the type of reverse mortgage you select, the appraised value of your home, current interest rates, and where you live. In general, the older you are, the more valuable your home, and the less you owe on it, the more money you can get.
Proprietary reverse mortgages, which are private loans that are backed by the companies that develop them. Proprietary reverse mortgages tend to be more costly than other home loans. The up-front costs can be high, so they are generally most expensive if you stay in your home for just a short time. They are widely available, have no income or medical requirements, and can be used for any purpose.

Advantages
1. There are no income(s) or medical requirements to qualify. However, you must qualify for a large enough reverse mortgage to pay off the existing loan entirely. You must also be at least 62 years of age or older.
2. Reverse mortgages can help homeowners who are house-rich but cash-poor stay in their homes and still meet their financial obligations.
3. When you sell your home or no longer use it for your primary residence, you, or your estate will repay the cash you received from the reverse mortgage, plus interest and other fees, to the lender. The remaining equity in your home, if any, belongs to you or to your heirs.
4. You can choose to receive the money from a reverse mortgage all at once as a lump sum, fixed monthly payments (for up to life), as a line of credit, or a combination of these.
5. The amount owed can never exceed the value of your home. Furthermore, if the home is sold and the sales proceeds exceed the amount owed on the reverse mortgage, the excess money goes to you or your estate.
6. You can deduct the interest on a reverse mortgage when you actually pay it, that is, when the loan is paid off.
7. The funds from a reverse mortgage can be used for anything. Common uses include supplementing retirement income to cover daily living expenses; repairing or modifying your home (i.e., widening halls or installing a ramp); covering health care expenses; paying off existing debts; taking a vacation; paying property taxes; and preventing foreclosure.

Disadvantages
1. Lenders generally charge origination fees and other closing costs for a reverse mortgage. Lenders also may charge servicing fees during the term of the mortgage.
2. The amount you owe on a reverse mortgage generally grows over time. Interest is charged on the outstanding balance and added to the amount you owe each month. That means your total debt increases over time as loan funds are advanced to you and interest accrues on the loan.
3. Reverse mortgages may have fixed or variable rates. Most have variable rates that are tied to a financial index and will likely change according to market conditions.
4. Reverse mortgages can use up all or some of the equity in your home, leaving fewer assets for you and your heirs.
5. Because you retain title to your home, you remain responsible for property taxes, insurance, utilities, fuel, maintenance, and other expenses. Therefore, for example, if you do not pay property taxes or maintain homeowner's insurance, you risk the loan becoming due and payable.
6. With a reverse mortgage, the lender sends you cash, and you make no repayments. So the amount you owe (your debt) gets larger as you get more and more cash and more interest is added to your loan balance.
   The above described language is only an example and each financial provider may include additional educational text or remove any of the information provided above. In addition, the parameters used in each calculation may be tailored to the specific service provider standards and as required by law. For example, the amount of equity required for the reversed mortgage may be higher or lower than the 55% of the example provided.

When the client's liquid assets are equal or greater than 50% but less than 69% of the client's total revolving debt and at least one of the client's revolving debt on the credit report is more than 30 days past due, the system provides a lump sum debt settlement option. Liquid assets include cash (checking and savings balance), bonds, stocks, certificate of deposit, and vested amount of the client's 401K. The system then calculates the amount of interest to be paid on the line of credit based upon the credit score of the client. If the client's credit score is 700 or higher, multiply the total revolving debt by 8.5% (divide interest by 12). If the client has a credit score between 650 and 699, the total revolving debt by 9.5% (divide interest by 12). If the client has a credit score between 600 and 649, the total revolving debt by 11.5% (divide interest by 12). Client's total approximate interest payments are also be calculated. The system takes the client's estimated line of credit payment and multiplies it by 180 months and 360 months (15 year and 30 year loan) and subtracts it from the original loan amount.

The client is provided with the following information:

Summary Content:
Your financial analysis indicates that you may be able to work out a lump sum debt settlement with your creditors.
A Lump Sum Debt Settlement helps you get rid of your debt obligations by paying a portion of the total debt owed to creditors, usually ranging from 30% to 60% of the total debt balance.
A lump sum debt settlement is viewed by most credit granting institutions negatively. You may have to pay taxes on the balance waived by the creditor. You should speak to a tax professional or attorney before considering this solution.

Additional Education:
Debt settlement may be a solution for some people who are experiencing legitimate financial hardships but cannot afford to repay their debts through debt management plans and also want to avoid filing bankruptcy.
Through lump-sum debt settlement, you negotiate with the creditor a reduced debt (usually in the 30% to 60% range of your current obligation) that you will complete immediately in one payment. Creditors agree to negotiate when they feel a settlement of the debt will be in their best interest:
1. The creditor knows if he/she has to refer the case to a collections agency, the collection agency will either have to be paid, or typically will take a percentage of the total amount collected from you. Often collection agencies may collect as much as 50% of the amount as their fee.
2. The creditor believes that the person requesting debt settlement is a prime legitimate candidate for bankruptcy. Knowing that in most bankruptcy cases he/she would receive nothing, he/she opts to take a discounted settlement on the debt rather than receive zero dollars in a bankruptcy.

Advantages
1. Debt settlement offers a possible strategy to remove your debts, if you do not participate in a debt management program and choose not to file for bankruptcy.
2. If successful, you will pay off a smaller fraction of the obligations that you owe at this time and avoid bankruptcy.
3. You have to negotiate individually with each creditor. If you cannot afford to pay all creditors at once, negotiate a settlement with the creditor with the smallest balance. Once that debt is paid in full, negotiate with the creditor with the next highest balance.

Disadvantages
1. Negotiating settlements requires the payment of a lump sum of money. If you do not have access to some funds, then you are not a candidate for debt settlement negotiation. Some sources for obtaining the lump sum may come from savings, refinancing your home, second mortgage, friends or relatives, sale of real or personal property, tax returns, IRA, 401K or settlements.
2. Every creditor will negotiate according to its own strategy, as far as how much it is willing to take. If your last creditor will not negotiate a settlement, you may still be forced to file for bankruptcy, after you have already paid off thousands of dollars to the other creditors.
3. Most creditors may report your settlement to the major credit bureaus. Be sure to ascertain whether your debt was correctly reported to the credit agency, and be sure it is reported as satisfied before you actually pay. You should ask for everything that your creditor agrees to in writing.
4. The portion of the debt you do not pay back to your creditors must be included on your tax return as taxable income. Thus, if you negotiate an average of 50% settlements, you actually are paying that 50% to the creditors directly AND you are paying the IRS taxes on the “forgiven” portion at your tax rate. Depending on how much debt is involved, the amount of the “forgiven” debt could be high enough to bump your tax bracket up forcing you to repay more.
   The above described language is only an example and each financial provider may provide additional educational text or remove any of the information provided above. In addition, the parameters used in each calculation may be tailored to the specific service provider standards and as required by law. For example, the interest rates may change based upon the current rates used at a particular time.

In addition to alternative solutions, the system provides secondary solutions. Secondary solutions are solutions that can be beneficial to the consumer based upon their situation and may be part of their Action Plan. Secondary Solutions are specific and address only one condition. For example, if a consumer were having problems with their credit score a Secondary Solution would be BrightScore, which assists the client on ways to improve their credit score. In another example, when a client goes through a divorce or loss of income, the Secondary Solution corresponds to Social Services. Secondary Solutions may include BrightScore, Tax Resolution Identifiers, Commercial/Business Debt Resources, Canceling PMI (Private Mortgage Insurance) Payments, Student Loan Help, Employment Services, Mortgage Foreclosure Help, and Social Services.

The BrightScore secondary solution is designed to assist the client in improving his or her credit score. Availability of this solution may be restricted by state law. The system automatically determines whether the solution is available to the client. If any of the following parameters are met, the system provides the secondary solution of BrightScore:
History of late payments to any of their revolving or installment trades.
Consumer has collection accounts.
Consumer has public records (tax liens, judgments, bankruptcy).
Consumer's credit utilization exceeds 40%.
Consumer has two or more credit inquiries within the past 6 months.
Consumer has no credit history.
Recently been denied credit.
Has not viewed their credit report within the last 12 months.
Denied a job due to credit issues.
Considering a job where credit score affects hiring decision.
Wants to dispute inaccuracies in their credit report.
Expresses indication of possible identify theft.
Planning a large purchase (home, boat, car, etc).
Questions about credit.
   The system provides the following information to the client if the BrightScore solution applies:

Summary Content:
BrightScore provides information to clearly understand and proactively manage your credit report and credit score.
BrightScore provides an easy-to-understand credit report along with a personalized analysis of your credit standing.
This online program offers consumers a personalized credit action plan and tools designed to improve your credit worthiness to help track and identify possible credit report inaccuracies.

Additional Education:
Based on extensive consumer research conducted by the Consumer Federation of America, the Government Accounting Office and others, it has been identified that a majority of consumers have difficulty truly and completely understanding their credit report and credit score. Credit reports and credit scores are the financial barometer by which consumers are measured when applying for credit cards and/or loans, applying for jobs, and being assessed insurance premiums. Therefore, BrightScore was developed as an educational tool and component counseling organization that will address this deficiency in consumer knowledge.
Consumers who purchase BrightScore initially receive a credit score. Based on the aforementioned research, it is known that consumers do not know what impacts their credit score. To address this, BrightScore translates the credit score into a BrightScore grading system that works similar to the academic grading scale assigning grades from A to F.
The credit score is further defined by breaking it down into the categories of data of which it is comprised called groupings. BrightScore, with help from outside credit report experts, has identified that credit scores are derived from assessing the value of five groupings. These are:
   Payment History
   Inquiries
   Credit Usage
   Delinquencies
   Public Records/Collections
Each BrightScore grouping is made of detailed factors that are the baseline pieces of information that can be found at the trade line level of a consumer credit report. These detailed factors are assigned different weights as they relate to the credit score. BrightScore, with help from outside credit report experts, has developed a methodology to rank the importance of these detailed factors as they relate to an individual's credit report and score.

Once the consumer's credit report is audited according to this methodology, accounts, groupings, and detailed factors are assigned a standing. From this standing, a group of recommended actions is generated that are particular to the detailed factors data and intervals. Actions suggest positive behaviors that build a strategy from which a consumer can work towards long-term creditworthiness. In addition, actions point out past positive behaviors that have contributed to a consumer's good credit rating.
Finally, the audit of a consumer's credit report allows BrightScore to recommend supplemental education content to address any identified deficiencies in behavior.

Factors that affect the credit score:
Credit History—Paying bills on time is generally the single most important contributor to a good credit score. Paying late on any bill, for any length of time, is a possible indication of future non-payment of debt and is almost always viewed negatively by lenders. Having accounts that were sent to collection agencies is even worse, though nowhere nearly as bad as declaring bankruptcy.
Outstanding Debt—The next most important factor is the amount you owe versus the amount of available credit at your disposal. The assessment of outstanding debt falls into several categories, and include credit cards, car loans, mortgages, home equity lines and more. The amount of available credit is also given consideration. Generally speaking, consumers who have a lot of available credit tend to use it; this makes them a less attractive credit risk.
New credit Applications—Careful study has shown that inquiries are an indicator of credit risk. Recent inquiries indicate a person may have outstanding accounts that are not yet part of the credit report. The more recent inquiries that appear on a borrowers credit file, the more likely a borrower may not be able to pay their bills as agreed.
Length of Credit History—The length of your credit history is important in determining if there is enough information on which to base the credit score. The longer the consumer has credit—particularly if it is with the same financial institution—the more points will positively impact their credit score. The credit report being used to generate a score must also have at least one account that has been updated within the previous six months. This will provide sufficient recent information for which to base a score.
Stability—Lenders like continuity. The risk factor may be lower for a lender if you demonstrate the same address for 3 years or more. The risk may be considered higher if you have had two or more addresses in the past 3 years, however, the risk may be considered less if you are a homeowner. As with residency, when it comes to employment continuity is also important. Ideally, lenders are looking for someone who has had the same employer for a number of years.
Types of Accounts—Consumers with the best scores have a mix of both revolving credit, such as credit cards, and installment credit such as mortgages and car loans. Statistically, consumers with a variety of experiences are better credit risks. In these cases, creditors tend to believe that these consumers have better money management skills.

Advantages
1. BrightScore provides education designed to help users clearly understand a consumer credit report.
2. It also provides an action plan, designed to improve creditworthiness, along with a tool to identify, track and dispute inaccuracies found within the credit report.
3. BrightScore is available online 24 hours a day 7 days a week.
4. The application is self-guided and provides 30 days of access upon purchase.
5. BrightScore offers education to non-purchasing consumers through their Credit Education 101 section.
6. Trained, certified counselors are available to assist with education and/or questions.
7. BrightScore provides an interactive glossary of terms to ensure complete understanding of credit report industry terms.

Disadvantages
1. BrightScore is only available online.
2. BrightScore is currently collecting data from only one credit-reporting agency.
3. BrightScore currently cannot service the following states: OH-NV-OR -UT-ID-ND.
   The above described language is only an example and each financial provider may provide additional educational text or remove any of the information provided above. The credit score education portion may have a different name, it may include more than one credit-reporting bureau, and it may give the user an extended or reduced amount of unlimited use. In addition, the parameters used in each calculation may be tailored to the specific service provider standards and as required by law. For example, the service may become available some of the states that currently prohibit it, or it become unavailable in other states if regulators prohibit the use of such programs. Other changes in the law or in the practice of the given provider may require a change in the description and guidance given to the client.

When clients have tax debt, the system identifies the problem and provides a secondary solution addressing that issue. In order to qualify, the client's tax debt must be greater than $5,000, or a minimum amount as required by law or by the provider's policies. Tax debt includes tax liens, but it does not include property taxes. When information is gathered from the client, the client is asked if he or she owes any property. If yes, these taxes will not be included for the provider. A client that qualifies is presented with the following solution:

Summary Content:
Your analysis indicates that you have some outstanding tax debt.
Paying any outstanding tax debt will help you avoid future actions such as garnishment of your wages.
We can refer you to one of our partners that may be able to help you with this debt.

Additional Education:
The IRS and each state have broad powers when it comes to collecting the taxes owed to them. These powers allow them to seize personal and business assets to pay off outstanding tax liabilities. This occurs when you have been avoiding their tax collection efforts. They will try to collect amounts owed them, and they have the power to seize your assets as the ultimate act of their collection efforts. They are not subject to the Federal “Fair Debt Collection Practices Act.”
While there are many reasons why you may not file a tax return, you need to be aware of the following:
Failure to file tax returns may be construed as a criminal act by the IRS.
This type of criminal act is punishable by one year in jail for each year not filed. This means you could potentially to lose your freedom for failure to file a tax return!

There are services/agencies that can help you address the following tax resolution issues.

Delinquent Tax Returns
If you do not file your income tax returns and ignore their notices to file a tax return, the IRS will prepare one for you, called a Substitute for Return (SFR). The IRS uses income that has been reported to them, such as wages, interest income, subcontractor payments, sale of property, etc., and then assumes you are single, have no dependents, and use the standard deduction.
This generally results in a larger tax bill, even though you did not actually file a tax return. You also have created other problems.
You cannot get a Payment Plan (see below) agreement without filing the missing returns—and the SFRs do not count.
You cannot submit an Offer in Compromise (see below) if there are missing returns.
Bankruptcy will not clear off old years if you did not file those returns.
The IRS will continue to try to collect on the SFR billings.

Offer in Compromise
The Internal Revenue Service may negotiate with you and resolve your tax liability for less than full payment under certain circumstances:
Doubt exists that the assessed tax is correct.
Doubt exists that the taxpayer could ever pay the full amount of tax owed. The IRS calculates a reasonable collection potential (RCP) and the minimum offer amount must generally be equal to (or greater than) your RCP.
Exceptional circumstances would create economic hardship should such the full amount be demanded.
You bear the burden of proof to show that the Offer in Compromise qualifies for consideration. You must show that your circumstances are strong enough to justify acceptance of Offer in Compromise.

Wage Garnishments
The IRS wage garnishment is a very powerful tool and can be financially crippling.
Once a wage garnishment is filed with an employer, the employer is legally required to collect a large percentage (usually 30-70%) of your paycheck and send it to the IRS.
The wage garnishment stays in effect until the IRS is fully paid or until the IRS agrees to release the garnishment.
You can appeal a garnishment, based on the following reasons: You have paid all your taxes before the levy was implemented; if you are in bankruptcy, the levy is subject to a stay until you are discharged; the IRS made a procedural error; the statute of limitations expired before the IRS sent the notice.

IRS Bank Levies
The IRS can issue a bank levy to obtain your cash in savings and checking accounts.
When the IRS levies a bank account, the levy is only for the particular day the levy is received by the bank.
The bank is required to remove whatever amount is available in your account that day (up to the amount of the IRS levy) and send it to the IRS in 21 days unless notified otherwise by the IRS.
This type of levy does not affect any future deposits made into your bank account unless the IRS issues another bank account levy.

IRS Payment Plans
In most cases, the IRS will accept some type of payment arrangement for past due taxes. In order to qualify for a payment plan with the IRS you must meet the following rules and provide the IRS with this information:
You must have filed all tax returns. (It is okay to owe money but you must file.)
You will need to disclose all your assets, including all cash and bank accounts.
You must not have cash available in a checking, savings, money market, or brokerage account to pay the IRS.
You must not have the capacity to borrow the amount owed to the IRS from other sources (i.e., a second mortgage on your home).
You must not have adequate equity in a retirement account from which you can borrow or liquidate; for example, an IRA, or a 401K.
These payments will continue until your outstanding tax liabilities are paid in full.

Liens
The IRS or other taxing authority can make your life miserable by filing a federal tax lien against you. A lien is a charge or a claim that IRS has on all of your property, up to the value of your tax obligation. A tax lien does not take property away or transfer your rights to the property.
Federal tax liens are public records that indicate you owe the IRS various taxes.
Because they are public records, tax liens show up on your credit report.
The IRS must give you a 30-day notice before levying upon and seizing your assets.
This often makes it difficult to obtain financing on an automobile or a home.
Federal tax liens also can tie up your personal property and real estate.
The lien also attaches to property acquired after the lien has been imposed.
Once a Federal tax lien is filed against your property, you cannot sell or transfer the property without a clear title.
Under Federal Tax Lien regulations, you cannot get a loan using as collateral property against which the IRS has placed a lien.
The lien continues in existence until the liability is satisfied or becomes unenforceable.

IRS Appeals
The IRS Appeal Division is to help “settle” disputes between the IRS and taxpayers. If a taxpayer does not agree with an IRS decision, he/she can appeal that decision and request a meeting to challenge the IRS decision.
The most common IRS decision that is appealed is that of an IRS Audit where the IRS has increased the taxpayer's tax liability.
Often this increase includes additional penalties and interest.
The taxpayer must file an Appeal Request within a certain time frame and follow the IRS guidelines for the request to be valid.

Collection Appeals
The Collection Appeal is an appeal by a taxpayer who has been served with an IRS Levy or Seizure.
The IRS allows you to file a Collection Appeal in these situations before they follow through on their levy or seizure.
The Collection Appeal is filed on a one-page form where you are given the opportunity to explain how the situation could be resolved without the IRS levy or seizure.
Your Appeal is assigned to an Appeals Officer who is required to make a decision on your Appeal within five days.

Advantages
1. Professional assistance may help you address some issues related to Federal/State tax problems, helping you pay off your tax debt without undue burden on your financial situation.
2. Issues that can addressed:
Delinquent Tax Returns
Offers in Compromise
Wage Garnishments
IRS Bank Levies
IRS Payment Plans
Liens
IRS Appeals
Collection Appeals

Disadvantages
1. It is not a guarantee that this solution will resolve your situation although many consumers do receive the benefits.
   The above described language is only an example and each financial provider may provide additional educational text or remove any of the information provided above. In addition, the parameters used in each calculation may be tailored to the specific service provider standards and as required by law. For example, procedural and administrative procedures are subject to change and the system changes as those parameters change.

Clients with commercial assets and debt are provided with a commercial/business debt solution when appropriate. This solution is available when the client has more than $10,000 in business debt, or any other amount required by law or by the provider's guidelines. A client that qualifies for this solution is presented with the following information:

Summary Content:
Your analysis indicates that you are concerned about business debt. There are services that businesses at risk can use to pay off their debt, restructure their business, and improve their cash flow.
Although many consumers have obtained relief from this solution, calling one of these providers does not guarantee you will not lose your business; each case is handled individually.
We suggest you talk to one of our referral partners, which may be able to provide you with a thorough evaluation of your situation.

Additional Education:
There are services that businesses at risk can use to resolve various categories of corporate indebtedness, helping them to avoid bankruptcy while restructuring their corporate debt and positioning the company for a return to profitability. The primary focus is on increasing cash flow for the business while restructuring all the various types of extended business debts from business lenders, corporate credit cards, vendors, creditors, suppliers, collection agencies, and attorneys.
The range of services offered includes:
Business Debt Resolution/Arbitration/Management
Business Bankruptcy/Alternatives
Business Debt Settlement
Business Financial Planning
Business Restructuring
Debt Negotiation
Judgment Proof
Financial Restructuring

There are debt management companies that service commercial debt situations. These services can:
Perform all creditor contact, so a company can focus on current business opportunities
Eliminate court appearances (especially meaningful for distant suit defendants)
Protect assets from litigating creditors
Satisfy creditors within a company's financial means
Maintain a suitable credit rating
Initiate cash flow acceleration
Facilitate profitable sales of inventory or services
Provides cash relief

Advantages
1. This solution can help you save your business if you are struggling with its debt.
2. You may be able to receive help and/or recommendations that will help you make your business successful.

Disadvantages
1. It is not guaranteed that your business will turn around if this solution is chosen.

The above described language is only an example and each financial provider may provide additional educational text or remove any of the information provided above. In addition, the parameters used in each calculation may be tailored to the specific service provider standards and as required by law. For example, the additional services may be added and other stated services may be removed based on the provider's parameters. In addition, the provider may provide business services as opposed to referring them out to other sources.

Clients with business debt and who are paying Private Mortgage Insurance (PMI) payments are offered the secondary solution of cancelling PMI payments. Estimated Mortgage Balance is divided by the Approximate Market Value of Home. If the result is 80% or less, cancelling PMI payments is shown as a possible solution and the following information is provided.

Summary Content:
Your financial analysis indicates that you currently have more than 20% equity in your home and you are currently paying Private Mortgage Insurance.
Since you have reached 20% equity in your home, you may be able to cancel the private mortgage insurance.
Canceling PMI payments can save you an average of 10% to 15% of your total mortgage payment. You should call your lending institution to ask them about their guidelines around canceling this insurance.

Additional Education:
To protect the bank in case of default from the owner, the lender will require any borrower to have Private Mortgage Insurance for any home that does not have at least 20% equity. Once you have reached 20% equity in your home by appreciation, improvements made to the home or paying down the principal balance of the mortgage (or any combination of the three), you can cancel the private mortgage insurance. Canceling PMI payments can save you an average of 10% to 15% of your total mortgage payment. On a $100,000 mortgage, that works out to $58 per month or $700 a year.
The Federal Homeowners Protection Act of 1998 requires lenders to inform their customers if they are no longer required to make PMI payments. This law, however, only affects loans taken out after Jul. 28, 1999; consumers with prior existing mortgages are not protected. The new legal requirement applies once loan payments reduce the principal balance to 80% of the original mortgage amount or the property has experienced an increase in equity sooner due to home improvements or market appreciation.
You can request cancellation of your PMI and will have to meet your lender's criteria. Each lender has its own criteria for canceling PMI, so call to request a copy of your lender's procedures. Typically, reducing the outstanding balance of your loan to 75% or 80% of the current property value is only the first requirement. You will probably need to provide verification of current market value through a professional appraisal report. The age of the loan, your on-time payment record and total loans outstanding on the property can also be determining factors.
Steps You Can Take to Cancel PMI:
Review your mortgage statement for the current principal balance of your loan.
Call your lender's customer service department for their PMI cancellation procedures.
Consult with a certified appraiser about providing an unbiased opinion of value.
Submit a written request and appraisal report to the lender according to their guidelines.

Advantages
1. You have the right to request cancellation of PMI when you pay down your mortgage to the point that it equals 80% of the original purchase price or appraised value of your home at the time the loan was obtained, whichever is less.
2. You also need a good payment history, meaning that you have not been 30 days late with your mortgage payment within a year of your request, or 60 days late within two years. Your lender may require evidence that the value of the property has not declined below its original value and that the property does not have a second mortgage, such as a home equity loan.
3. Canceling PMI payments can save you an average of 10% to 15% of your total mortgage payment. On a $100,000 mortgage, that works out to $58 per month or $700 a year.
4. If PMI has not been canceled or otherwise terminated, coverage must be removed when the loan reaches the midpoint of the amortization period. On a 30-year loan with 360 monthly payments, for example, the chronological midpoint would occur after 180 payments. This provision also requires that the borrower must be current on the payments required by the terms of the mortgage.

Disadvantages
1. Some mortgage providers may be hesitant in cancelling your PMI payments if you have had a negative payment history with them.
   The above described language is only an example and each financial provider may provide additional educational text or remove any of the information provided above. In addition, the parameters used in each calculation may be tailored to the specific service provider standards and as required by law. For example, the ratio of debt to equity required may vary.

Clients with student loan debt are presented with student loan help solutions. In order to qualify, the client must have more than $7,500 in student loan debt. This option is not available for loans where payments have been 120 days late at least three times. Some providers may restrict the solution to federal or private loans only, while others can include both types of loans. The client that meets the required parameters is presented with the following information:

Summary Content:
1. Your financial analysis indicates that you currently have some student loan debt.
2. There are many programs that will help you manage this debt. It is not guaranteed that these programs will stop collection efforts if the debt is too delinquent.
3. We can refer you to one of our partners that may be able to assist you in finding a program that meets your needs.

Additional Education:
You are responsible for repaying your student loans even if you do not graduate, have trouble finding a job after graduation, or just did not like your school. If you do not make any payments on your student loans for 270 days and do not make special arrangements with your lender to get a deferment or forbearance, your loans will be in default. Defaulting on your student loans has serious consequences:
Your loans may be turned over to a collection agency.
You will be liable for the costs associated with collecting your loan, including court costs and attorney fees.
You can be sued for the entire amount of your loan.
Your wages may be garnished. (Federal regulations limit the amount that may be garnished to 10% of the borrower's take-home pay.)
Your federal and state income tax refunds may be intercepted.
The federal government may withhold part of your Social Security benefit payments. (The US Supreme Court upheld the government's ability to collect defaulted student loans in this manner without a statute of limitations in Lockhart v US (04-881, December 2005).)
Your defaulted loans will appear on your credit record, making it difficult for you to obtain an auto loan, mortgage, or even credit cards. A bad credit record can also harm your ability to find a job.
You will not receive any more federal financial aid until you repay the loan in full or make arrangements to repay what you already owe and make at least six consecutive, timely monthly payments. (You will also be ineligible for assistance under most federal benefit programs.)
You will be ineligible for deferments.
Federal interest benefits will be denied.
You may not be able to renew a professional license you hold.
In addition, of course, you will still owe the full amount of your loan.

OPTIONS
Deferments. During deferment, the lender allows you to postpone repaying the principal of your loan for a specific period of time. Deferments are commonly granted for:
   Students who are enrolled in undergraduate or graduate school.
   Disabled students who are participating in a rehabilitation training program.
   Unemployment.
   Economic hardship.
Most federal loan programs allow students to defer their loans while they are in school at least half time. For Perkins Loans and Subsidized Stafford Loans, no interest accrues during the deferment period because the federal government pays the interest. For other loan programs, such as the unsubsidized Stafford loan, the interest still accrues during the deferment period. Students can postpone the interest payments on such loans by capitalizing the interest, which increases the size of the loan. (Capitalizing the interest adds it to the loan principle. This increases the amount of the debt, which means you will be paying interest on interest, in addition to interest on the principal.)
If you are thinking about defaulting on your student loans, ask the lender whether you are eligible for a deferment (or forbearance) BEFORE you default. You cannot receive a deferment if your loan is in default.
For more information about deferments, contact the financial aid office at the school that issued the loan and/or the original lender or current servicer of your loan.
Forbearance. During forbearance, the lender allows you to postpone or reduce your payments, but the interest charges continue to accrue. The federal government does not pay the interest charges on the loan during the forbearance period. You must continue paying the interest charges during the forbearance period. Note also that there are limits on the length of forbearance. Forbearances are typically granted in 12-month intervals for up to three years.
Forbearances are not granted automatically. You must submit an application and provide documentation to support your request for a deferment. Forbearances are granted at the lender's discretion, usually in cases of extreme financial hardship or other unusual circumstances when the borrower does not qualify for a deferment. Do not stop making payments on your student loans until after you are notified that your forbearance has been granted.
If you are thinking about defaulting on your student loans, ask the lender whether you are eligible for a forbearance (or deferment) BEFORE you default. You cannot receive a forbearance if your loan is in default. For more information about forbearances, contact the financial aid office at the school that issued the loan and/or the original lender or current servicer of your loan.

Getting Out of Default
To get out of default, you need to make arrangements with your servicer or lender to repay the loan. Once you have made six regular payments, you will be eligible for additional Title IV aid. After you have made twelve regular payments and have applied for and received rehabilitation, you will no longer be considered in default. At this time, record of the default will be removed from the reports to credit reporting bureaus.
For information about your options, contact the servicer of the loan and/or the original lender. The financial aid office at your school should be able to tell you the name, address and telephone number of your lender and can also provide you with help and advice about repayment problems.

Collection Agencies
If you default on your student loans, the lender or guarantor may use a collection agency to collect the loan. The collection agency's costs are added to the amount due, and you are required to repay them in addition to the amount due on the loan.
Federal regulations state that a borrower who has defaulted on his or her student loans may be required to pay reasonable collection costs in addition to other charges, such as late payment fees. What constitutes reasonable, unfortunately, is not very well defined; and acceptable costs may be up to 40% of the loan principal.
When consolidating a defaulted loan, collection costs of up to 18.5% of the outstanding principal and interest may be included in the amount consolidated. Therefore, a collection agency might be willing to reduce its fees to 18.5% if you consolidate your loan but the collection agency is under no obligation to do so. If you consolidate your loans and the collection agency does not reduce its fees, you must pay the amount in excess of 18.5%.
If you think the collection costs are excessive, you can ask the collection agency to provide a detailed itemization of the actual costs incurred in collecting the loan. Although federal regulations are murky on this point, it appears that the costs must be based on either the actual costs incurred in collecting the loan or the average costs incurred for similar actions taken to collect loans in similar stages of delinquency.

Preventing Default
1. Make sure you understand your options and responsibilities before taking out a loan.
2. Make your payments on time.
3. Notify your lender or servicer promptly of any changes that may affect the repayment of your loan. If you move or change your address, let them know. Likewise, tell them about name changes (e.g., because of marriage), graduation or termination of studies, leaves of absence and transfers to another school.
4. If you encounter financial difficulties, consider applying for a deferment or forbearance on your loans. It is better to defer your payments than to go into default. Ask your lender about these options while you are still making payments, before you default on your loan. You will not be able to get a deferment or forbearance after you default.
5. If you are having trouble making payments, your lender may be able to suggest alternate repayment options, such as graduated repayment or income sensitive repayment. The types of available repayment options currently depend on whether the loan was issued under the FFELP or FDSLP (Direct) programs.
6. Consider using a consolidation loan to combine all of your educational loans into one big loan. This lets you send your payments to just one lender. You may also be able to extend the term of the loan in order to reduce the size of your monthly payments.
7. Keep careful records regarding your loan; put copies of all your letters, canceled checks, promissory notes, notices of disbursement, and other forms in a file folder.

Advantages
1. Our referral partners may be able to help you if you have encountered financial difficulties with your student loans.
2. Our referral partners will try to seek options while you are still making payments or if the loans are currently delinquent.
3. Your lender may be able to suggest alternate repayment options depending on your willingness to pay off the debt.

Disadvantages
1. Deferments are not granted automatically. Do not stop making payments on your student loans until after you are notified that your deferment has been granted.
2. During forbearance, the lender allows you to postpone or reduce your payments, but you must continue paying the interest charges during the forbearance period.
3. If you default on your student loans, the lender or guarantor may use a collection agency to collect the loan. The collection agency's costs are added to the amount due, and the borrower is required to repay them in addition to the amount due on the loan. Collection costs can legally be as high as 40% or more.
4. It is not guaranteed that this solution will stop collection efforts if the debt is too delinquent. Although many consumers do find the benefits of this solution, it unfortunately does not work for everyone.
   The above described language is only an example and each financial provider may provide additional educational text or remove any of the information provided above. In addition, the parameters used in each calculation may be tailored to the specific service provider standards and as required by law. For example, regulation of student loans may required change in the information provided to the client. The financial entities may also provide loan consolidation services, as opposed to suggesting referral partners.

Clients that have no income (including spousal income), select reduced income as a root cause, or who choose “seeking additional income” in lifestyle issues on the assets screen are presented with employment services options. If the client's only source of income is disability, welfare, or worker's compensation, however, employment services solution is not provided. The following information is provided to the client:

Summary Content:
Your financial analysis indicates that you may be in need of additional income. There may be partners available to help you obtain employment.
When seeking employment it is always good to use several sources like newspapers, internet, and even friends to maximize the chances of obtaining a job.
We can refer you to one of our partners, who are dedicated to helping consumers search for employment.

Additional Education:
It often takes months of time and effort to find a job that matches your qualifications and desires. Actively pursuing multiple leads will maximize your search efforts and reduce the time it takes you to find employment; this means devoting as much time as you can to your job search. If you are unemployed, treat your job search like a full-time job by waking up early and “working” a full day. If you are working part-time or going to school, it is still important to devote time daily to your job search. Since the root cause of your situation has been a result of reduced or no income, you may be able to work with a professional resource to find employment. Job search methods include:
Personal contacts.
School career planning and placement offices.
Employers.
Classified ads.
Internet networks and resources.
State employment service offices.
Federal government.
Professional associations.
Labor unions.
Private employment agencies and career consultants.

Advantages
1. This solution can assist you in finding employment and will enable you to gain control of your finances.
2. Employment agencies work to fill specific positions available within companies. Their focus is on finding an individual who possesses the job skills specified by the employer. Using one of these organizations increases your chances of being hired.
3. Career counseling services may also help you with career planning and decision making rather than just finding you a job.
4. Internet job boards (for example, Monster, CareerBuilder) list positions posted by employers, nationally and (occasionally) worldwide, making them ideal for searching for jobs out of your area should this be a necessity.

Disadvantages
1. The above solutions focus on fitting you into a pre-defined slot. Another strategy is to network your skills to find a position/occupation that meets your career goals.
2. Limiting your job search by using only one employment service organization may reduce your chances of seeking a job quickly. You should explore every option you find available when seeking employment.
   The above described language is only an example and each financial provider may provide additional educational text or remove any of the information provided above. In addition, the parameters used in each calculation may be tailored to the specific service provider standards and as required by law. For example, regulation of student loans may required change in the information provided to the client.

Clients with mortgage debt who are at risk of foreclosure are presented with mortgage foreclosure help. If a mortgage (including HELOC, second mortgage, etc.) is more than thirty days past due, the client is presented with the following information.

Summary Content:
Your financial analysis has indicates that you may need some help paying your mortgage.
We have partners that may be able to help save your home from a possible foreclosure.
Regardless of how delinquent you are on your mortgage payment, seeking additional help with one of our partners may enable you to save your home.

Additional Education:
When you miss your mortgage payments, your lender can take foreclosure steps to repossess (take over) your home. When this happens, you must move out of your house. If your property is worth less than the total amount you owe on your mortgage loan, you are responsible for the difference. If that happens, you not only lose your home, you also would owe the lender an additional amount, which is called a “deficiency judgment.” Both foreclosures and deficiency judgments could seriously affect your ability to qualify for credit in the future, so you should avoid foreclosure if at all possible.
You and your lender may be able to develop a workout proposal or agreement that makes financial sense to the lender in protecting its investment and saving them money in the long run, while you avoid foreclosure.

Options Available Include:
Forbearance—Forbearance can be an option for someone experiencing temporary financial difficulty. In forbearance, a lender agrees to let you postpone your payments to them for a short period of time. The debt has not been forgiven; you are just allowed you to pay what you owe at a later date. A forbearance mortgage is often combined with other programs that bring your monthly mortgage payments current after a negotiated period of time.
The lender may grant forbearance of principal, interest or both. You will always be responsible for repayment of the accrued interest charges. You can make interest-only payments, or the interest will be added on to the principal. You must sign a forbearance agreement that states the lender will require you to pay the amount you owe at a later date.
Repayment—A lender may suggest a mortgage repayment plan if you are behind in your payments but will soon be able to make payments again in the immediate future. This slowly lets you catch up on your monthly mortgage payments. You simply add an additional portion of the past due amount to monthly mortgage payments until your balance is current.
Mortgage Modification—A lender will usually suggest a mortgage modification only if you can make your current monthly mortgage payment now but can't come up with the past due amount. They can either add the past due amount to your existing loan or extend the length of your mortgage loan. It is very important that you follow through on any promises you make to your lender to bring your account current. A lender may also suggest you refinance through a different loan program to lower your monthly mortgage payment to a more affordable amount.
Pre-foreclosure Sale—If you qualify, you can try to sell your home for a fair market value; and your lender may forgive any remaining mortgage balance if your home sells for less than you paid for it. To qualify, your mortgage must be at least two months overdue and your income must have been recently reduced or your expenses increased, due to no fault of your own. Under a pre-foreclosure agreement, you will generally have from three to five months to sell your home before foreclosure takes place.
Giving Back Your Home/Deed in Lieu of Foreclosure—If all your available options have failed, you may qualify for giving back your “deed-in-lieu of foreclosure.” You will lose your home, but your credit will not be as negatively impacted as it would if a foreclosure had taken place. Whatever you do, you should explore every available option to avoid foreclosure on your home.
Reinstatement—A reinstatement program may be arranged if you are behind in your payments but will be able to and agree to pay a lump sum amount on a specific date to bring your monthly mortgage payments current.
Short Sale—A short sale occurs when the lender agrees to write off the portion of a mortgage that is higher than the value of the home. Banks do not like excess inventory and bad loans on their books; therefore, if they see an opportunity where they can sell the property without a huge loss, they will do it. The lender will be considering many factors in deciding whether to approve a short sale, including:
Whether the seller is deserving of a break, due to financial hardship caused by unforeseen circumstances such as layoffs, divorce, or illness.
Whether it would be cheaper to simply repossess the house, make any necessary repairs, and sell it through a real estate agent.
The number of other properties the mortgage lender currently has in default.
Whether there are co-signors who could be held responsible for the balance owed on the mortgage.
Although a short sale can offer a softer financial landing than bankruptcies or foreclosures, it is a complex real estate transaction to prepare and get approved, involving as much (if not more) paperwork than an original mortgage application. Instead of proving your credit worthiness and financial stability, you must prove you are broke by showing proof that you have no savings, investments, trusts, liquid retirement funds, or other finances to use. In addition, you will be responsible for paying for any remaining difference between your home's value and the balance on your mortgage, which is considered a forgiveness of debt and, in virtually all cases, taxable.

Special Notes:
It is very important that you follow through on any promises you make to your lender to bring your account current. Work with your lender and let them know early on that you need help. Your priority is avoiding mortgage foreclosure if at all possible.
One last thing: Beware of scams! If you are selling your home without professional guidance, beware of buyers who try to rush you through the process. Unfortunately, there are people who may try to take advantage of your financial difficulty. Be especially alert to the following:

Phony Counseling Agencies. Some groups calling themselves “counseling agencies” may approach you and offer to perform certain services for a fee. These are often services you could do for yourself, for free, such as negotiating a new payment plan with your mortgage company or pursuing a pre-foreclosure sale. If you have any doubt about paying for such services, call a HUD-approved housing counseling agency. Do this before you pay anyone or sign anything.

Advantages
1. Our partners try to workout a proposal (avoiding foreclosure) that is based on an agreement between the borrower and the lender that makes sense to the lender and saves them money in the long run. It may be able to save your home from foreclosure.
2. Foreclosure cases can be assessed up to 4 days before the sale date. Sale date is the day they sell the consumers home in auction. You may have the ability to still save your home.
3. Understanding your options when trying to save a home from foreclosure is very important. Some of these options are Forbearance, Repayment plan, Mortgage Modification, Pre-foreclosure sale, Deed in Lieu of Foreclosure, Reinstatement, and Short Sale.
4. Usually, under normal situations, a foreclosure can be stopped within a period of 4 to 6 weeks, with the help of a foreclosure service.

Disadvantages
1. If you try to save your own home on your own, you must beware of scams. Solutions that sound too simple or too good to be true usually are.
2. Although many consumers have been able to find relieve using this solution, it does not work for everyone. Each case is handled on an individual basis.
   The above described language is only an example and each financial provider may provide additional educational text or remove any of the information provided above. In addition, the parameters used in each calculation may be tailored to the specific service provider standards and as required by law. For example, regulation of student loans may required change in the information provided to the client.

Clients who select any of the following as a root cause or lifestyle issue are provided with the social services solution: death of family member, divorce or separation, medical, concerned about possible depression, gambling help, concerned about other addictions, past due on utility bills. Clients who select either of these options receive the following information:

Summary Content:
There are Social Service providers that may be able to help situations involving divorce, loss of income, bankruptcy, medical illness, situations dealing with your family, and other circumstances.
We may be able to refer you to one of our social services partners for more information.

Additional Education:
Social Service programs have helped millions of consumers get back on their feet, financially and otherwise. These programs provide assistance via individuals trained to help people that have experienced very difficult situations in their life. Giving Social Service programs a chance to help with an unexpected situation may help you get your life back in order much sooner than if you try to do it alone.

Advantages
1. Social Service programs are generally free.
2. There are many resources and organizations that focus all of their efforts in helping families with unforeseen circumstances.
3. There is a good deal of education available that has helped many families cope with unexpected events.

Disadvantages
1. Many of these programs require you to make lifestyle changes in order for them to be successful.
2. The programs will not work unless you are willing to give them a fair trial and follow the directions given.
   The above described language is only an example and each financial provider may provide additional educational text or remove any of the information provided above. In addition, the parameters used in each calculation may be tailored to the specific service provider standards and as required by law. For example, additional events can trigger the social services solution.

Another option that is provided to the client is the creation of a “Financial Action Plan,” an interactive tool that will be utilized during a counseling session to help individuals and their families with their budgeting needs. This tool enables the consumers in making the necessary changes to their spending patterns and to achieve their financial goals. It also provides counselors with a tool to provide sound advice to the client based on the client's specific situation.

The budgeting process presented in the Financial Action Plan allows the average consumer to develop a comprehensive strategy that breaks down a spending plan into a series of actions that effectively tackle budget related categories to foster a change in the client's behavior and support the new repayment plan. In addition to the information gather during data collection, the client can provide additional information regarding expenses. The client is then provided with information to be used in developing a sound financial plan. The information provided includes data obtained through a “National Average Tool,” which allows the system to display national average data obtained from the department of labor. The data is segmented by demographic characteristics such as region, income, number of dependents, and number of vehicles, among others.

The system performs a “Variance Calculation” where each item that has been entered in the budget is utilized to calculate the difference between the amount entered and the national average. The results are known as “the variance.” Variance results are divided into negative and positive variance. Negative variance indicates that the client's spending patterns are above average and must be reduced in order to positively affect the disposable income. Positive variance indicates that the client's expenses are below the national average. Every Budget item is ranked based on the variance amount as follow:
1. Highest negative variance
2. Lowest negative variance
3. Lowest positive variance
4. Highest positive variance
   The client may or may not be provided with the variance calculation and ranking. The system, however, uses this information to highlight the top three budget items that require immediate action. A provider may display more or less than three budgetary items. The next step is to populate talking points through the action boxes that are displayed to the client. This step enables clients to make decisions. Furthermore, the action boxes allow counselors to discuss the budget tips and how these items could be further adjusted until reaching the recommended amount.

The system also provides a recommended budget or plan. The plan provides a new proposed amount for each budget item. The amount to be displayed equals or is lower than national average data. For instance, if the client's current expense is less than national average, the amount to be populated in the recommended budget is their current expense. If the client's current expense is higher than the national average, however, the system recommends the national average data as the new monthly amount. Providers may utilize other standards to determine the proposed budget amount. For example, a provider may utilize regional averages, or the averages of their specific client base. The system provides a budget summary that emphasizes the benefits of adopting the new financial plan and how these changes will help the client benefit from the success on DMP. The summary can also be utilized by counselors advising the client.

Under some circumstances the recommended plan may result in a negative cash flow, in that case, an additional action box is automatically populated, indicating that the client must increase their income in order to achieve a positive cash flow. On the other hand, in the event the recommended budget indicates a surplus amount, the counselor will discuss with the client the possibility of increasing their DMP payment in order to reduce the repayment plan and increase their total savings.

In addition to the information presented to the client on the screen, a PDF document can be sent to each client through e-mail, a paper copy may also be mailed to the client. Providers can create different ways in which the financial plan is provided to the client. This document provides detailed information for each budget item that helps the client further adjust their budget and perhaps obtain additional savings.

In one embodiment of the invention, the system is completely web based. In another embodiment of the invention, the system exists as a stand-alone software package for the buyer to use at his or her discretion.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A method for rendering financial counseling services, such method comprising the steps of:
a. receiving information concerning a debtor's financial condition;
b. evaluating such debtor's financial condition; and
c. recommending a course of action to improve such debtor's financial condition.

2. The method according to claim 1, wherein:
the financial counseling is rendered over a global computer network.

3. The method according to claim 2, wherein:
the global computer network comprises the Internet.

4. The method according to claim 1, wherein the step for receiving information concerning a debtor's financial condition further comprises:
a. debtor inputting personal data;
b. debtor inputting income data;
c. debtor inputting expenses data; and
d. debtor inputting debt data.

5. The method according to claim 4, further comprising:
maintaining security of the debtor input personal information, income information, expense information and debt information.
